(19) United States
(12) Patent Application Publication
(10) Pub. No.: US 2009/0235341 A1
(43) Pub. Date: Sep. 17, 2009

(54) NETWORK INTERFACE APPARATUS, PRINT CONTROL METHOD, PRINT CONTROL PROGRAM, AND IMAGE FORMING APPARATUS

(75) Inventor: Hiroshi Hashimoto, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/402,048

(22) Filed: Mar. 11, 2009

(30) Foreign Application Priority Data
Mar. 14, 2008 (JP) 2008-065578
Jun. 6, 2008 (JP) 2008-148848
Jan. 22, 2009 (JP) 2009-011722

(51) Int. Cl. H04L 9/32; G06F 15/16; G06F 15/177

(52) U.S. Cl. 726/5; 709/224; 709/221

(57) ABSTRACT

A network interface apparatus is connected to an image forming apparatus, and communicates with an information processing apparatus for transmitting a print data and an authentication server for performing an authentication of a user. The network interface apparatus receives the print data from the information processing apparatus, stores the print data, transmits an authentication request including user identification information to the authentication server according to a reception of the user identification information for identifying the user, and determines whether a communication with the authentication server is available. In a case where it is determined that the communication with the authentication server is available, the network interface apparatus obtains the print data according to the user identification information from the stored print data. In a case where it is determined that the communication with the authentication server is not available, the network interface apparatus turns off a setting of storing the received print data. The network interface apparatus transmits the print data to the image forming apparatus to print the obtained print data or to print the received print data in a case where the setting is turned off.

### BACKGROUND OF THE INVENTION

1. Field of the Invention

The present invention is related to at least one of: a network interface apparatus arranged in an image forming apparatus communicably connected with an information processing apparatus generating a print data and an authentication server authenticating a user; a print control method; a print control program; and the image forming apparatus.

2. Description of the Related Art

Conventionally, a printing system of so-called “Pull Print (stored printing or spooled printing)” has been suggested that enables a printing apparatus to output a print data upon a user's a print request with respect to the print data temporarily spooled or stored to a server from the printing apparatus.

Japanese Patent Application Laid-Open No. 2006-99714 can be mentioned as an example of the printing system of “Pull Print (stored printing).” Japanese Patent Application Laid-Open No. 2006-99714 discloses a print control system that includes an authentication function in a multi-functional apparatus and takes security into consideration.

Specifically, Japanese Patent Application Laid-Open No. 2006-99714 discloses a configuration in detail as follows. As illustrated in FIG. 4, a user first logs on to a client PC (Personal Computer) 100 ((1)-1). Then, a print instruction is given to a printer from the client PC 100 ((1)-2). Then, the client PC 100 transmits the generated print data to a print server 200 ((2)-1) to cause the print data to be stored in a predetermined storage location of the print server 200 ((2)-2). At this moment, the print data is not transmitted to the printing apparatus.

Next, the client PC 100 generates a bibliographic information data of the print data transmitted to the print server 200, and transmits the generated bibliographic information data to a print administration server 400 to cause the bibliographic information data to be stored in a predetermined storage location of the print administration server 400 ((3)-1). When a bibliographic information data file is stored by the client PC 100, the print administration server 400 analyzes the bibliographic information data file, and registers the bibliographic information to a bibliographic information DB ((3)-2). Next, when a multi-functional apparatus 300 detects an IC card 410 with a card reader, the multi-functional apparatus 300 reads individual authentication information in the IC card 410, and transmits the read individual authentication information, as an authentication request, to the print administration server 400 ((4)-1). When the print administration server 400 receives the individual authentication information from the multi-functional apparatus 300, the print administration server 400 performs an authentication processing of the individual authentication information based on an IC card authentication table stored in an external memory apparatus of the print administration server 400, and replies the authentication result to the multi-functional apparatus 300 ((4)-2).

Next, when the multi-functional apparatus 300 receives from the print administration server 400 the authentication result (a login user ID of the client PC 100) to the effect that the authentication has succeeded, the multi-functional apparatus 300 transmits a print data list request to the print administration server 400 ((5)-1).

It is assumed that the print data list request includes the login user ID of the client PC 100. When the print administration server 400 receives the print data list request from the multi-functional apparatus 300, the print administration server 400 searches the bibliographic information DB with the login user ID included in the print data list request to generate a print data list corresponding to the login user ID, and replies the print data list to the multi-functional apparatus 300 ((5)-2). When the multi-functional apparatus 300 receives the print data list from the print administration server 400, the multi-functional apparatus 300 displays the print data list on a UI of an operation unit 308. Then, when the user selects a print data and gives the print instruction, the multi-functional apparatus 300 transmits a print request (output instruction) of the selected print data to the print administration server 400 (6).

When the print administration server 400 receives the print request (output instruction) of the print data from the multi-functional apparatus 300, the print administration server 400 searches the bibliographic information DB for the bibliographic information of the print data of which the output instruction has been given, using the login user name of the client PC 100 and a timestamp of the print data as a key, to identify the print server 200 storing the corresponding print data based on the found bibliographic information, and transmits the print instruction of the corresponding print data to the print server 200 (7). When the print server 200 receives the print instruction from the print administration server 400, the print server 200 transmits the print data to the multi-functional apparatus 300 based on the print instruction to cause the multi-functional apparatus 300 to print the print data (8).

According to the above-described method, the time when a printed material is output is when the user gives the print request from the printing apparatus to the server. Thus, the printed material can be prevented from being left alone for a long time, and a secure print system can be achieved. However, there exists a problem that in a case where the communication with the authentication server is unavailable, such as where the authentication server is down, the printing cannot be performed because the authentication cannot be performed, which results in lagging the work.

To solve this problem, a technology described in Japanese Patent Application Laid-Open No. 2005-173816 has been disclosed. Japanese Patent Application Laid-Open No. 2005-173816 discloses an example of a Pull Print system that enables a printing apparatus to output a print data by giving a print request with respect to the print data temporarily stored although the Pull Print system does not have a function to present to the user only jobs corresponding to user information from among the stored print data. In this method, in a case where the communication with the authentication server is unavailable, a local authentication is performed as to whether a user giving an authentication request is an owner of a document that the user is going to print, using previously-registered authentication information of the printing apparatus itself.

Therefor, the printing can be performed even in a case where the communication with the authentication server is unavailable.

### SUMMARY OF THE INVENTION

According to one aspect of the present invention, a mechanism to avoid lagging printing work is provided even in a case where the authentication cannot be performed because, for example, the authentication server is down.

According to another aspect of the present invention, a mechanism is provided that enables deleting the print data even with such printer that is unable to delete a print data with an operation unit.

The present invention relates to a network interface apparatus connected to an image forming apparatus and communicating with an information processing apparatus for transmitting a print data and an authentication server for performing an authentication of a user, the network interface apparatus including: a reception unit that receives the print data from the information processing apparatus; a memory unit that stores the print data; a request transmission unit that transmits, according to a reception of user identification information for identifying the user, an authentication request including the user identification information to the authentication server; a determination unit that determines whether a communication with the authentication server is available; an acquisition unit that obtains the print data according to the user identification information from the print data stored by the memory unit in a case where the determination unit determines that the communication with the authentication server is available; a cancellation unit that turns off a setting of causing the memory unit to store the print data received by the reception unit in a case where the determination unit determines that the communication with the authentication server is not available; and a data transmission unit that transmits the print data obtained by the acquisition unit, or the print data received by the reception unit in a case where the setting is turned off by the cancellation unit, to the image forming apparatus to cause the image forming apparatus to print the print data.

Other features and advantageous of the present invention will be apparent from the following description taken in conjunction with the accompanying drawings, in which like reference characters designate the same or similar parts throughout there of.

### BRIEF DESCRIPTION OF THE DRAWINGS

FIG. 1 is a figure illustrating an example of the configuration of a secure print system.

FIG. 2 is a figure illustrating an example of the configuration of a secure print system 1 according to the present embodiment.

FIG. 3 is a figure illustrating a hardware configuration of an LDAP server 200 and a client PC 300.

FIG. 4 is a figure illustrating a hardware configuration of a printing apparatus 1000.

FIG. 5 is a figure illustrating a hardware configuration of a NIC 700.

FIG. 6 is a block diagram illustrating a configuration of the secure print system 1 according to the present embodiment.

FIG. 7 is a flowchart illustrating an example of a print job introduction processing procedure of the secure print system 1.

FIG. 8 is a flowchart illustrating an example of a print job output processing procedure of the secure print system 1.

FIG. 9 is a flowchart illustrating an example of the print job output processing procedure of the secure print system 1.

FIG. 10 is a flowchart illustrating an example of the print job output processing procedure of the secure print system 1.

FIG. 11 is a flowchart illustrating an example of the print job output processing procedure of the secure print system 1.

FIG. 12 is a flowchart illustrating an example of the print job output processing procedure of the secure print system 1.

FIG. 13 is a flowchart illustrating an example of a detailed procedure of output processing of the secure print system 1.

FIG. 14 is a flowchart illustrating an example of an LDAP server monitoring processing procedure of the secure print system 1.

FIG. 15 is a flowchart illustrating an example of a user notification processing procedure of the secure print system 1.

FIG. 16 is a figure illustrating an example of setting information 802.

FIG. 17 is a figure illustrating the details of a monitored port 907.

FIG. 18 is a figure illustrating an example of messages displayed on the printing apparatus 1000.

FIG. 19 is a figure illustrating the details of a job 310.

FIG. 20 is a figure illustrating the details of a print information administration header 311.

FIG. 21 is a figure illustrating the details of job information 820.

FIG. 22 is a figure illustrating the details of a job list 805.

FIG. 23 is a figure illustrating the details of an execution list 804.

FIG. 24 is a figure illustrating the details of a file system 501.

FIG. 25 is a figure illustrating the details of an IC card 410.

FIG. 26 is a figure illustrating an example of user information 210.

FIG. 27 is a figure illustrating the details of an LDAP directory.

FIG. 28 is a figure illustrating an embodiment of the secure print system 1.

FIG. 29 is a flowchart illustrating an example of a deletion confirmation processing procedure of the secure print system 1.

FIG. 30 is a flowchart illustrating an example of a deletion processing procedure of the secure print system 1.

FIG. 31 is a flowchart illustrating an example of the detailed procedure of output processing of the secure print system 1.

FIG. 32 is a flowchart illustrating an example of the LDAP server monitoring processing procedure of the secure print system 1.

FIG. 33 is a flowchart illustrating an example of the user notification processing procedure of the secure print system 1.

FIG. 34 is a figure illustrating the details of the IC card 410.

FIG. 35 is a figure illustrating an example of the user information 210.

FIG. 36 is a figure illustrating the details of the LDAP directory 201.

FIG. 37 is a figure illustrating an example of a deletion setting 840.

FIG. 38 is a figure illustrating an example of execution card information 850.

FIG. 39 is a figure illustrating an example of recovery time information 860.

FIG. 40 is a figure illustrating an embodiment of a secure print system la.

FIG. 41 is a figure illustrating an embodiment of a secure print system lb.

FIG. 42 is a flowchart illustrating an example of the print job output processing procedure according to the third embodiment of the secure print system 1.

FIG. 43 is a flowchart illustrating an example of the print job output processing procedure according to the third embodiment of the secure print system 1.

FIG. 44 is a flowchart illustrating an example of the setting information 802 according to the third embodiment of the secure print system 1.

FIG. 45 is data structure illustrating an example of the setting information 802.

### DESCRIPTION OF THE EMBODIMENTS

An exemplary embodiment of a secure print system according to the present embodiment will be hereinafter described in detail with reference to the attached figures.

### First Embodiment

Because of the conventional configuration that in addition to the authentication server each of the printing apparatuses has the authentication function, user information is managed in various locations. Thus, there exists a problem that in a case where the user information is to be updated, a necessity arises to update the authentication information in each printing apparatus as well as the information in the authentication server, and in a case where multiple printing apparatuses are installed in an office as seen in recent years, the updating work is very cumbersome. In addition, there exists a problem that the work comes to a standstill when all the authentication servers are down, as the authentication is expected to be always performed somewhere. The present embodiment solves at least a portion of this problematical point.

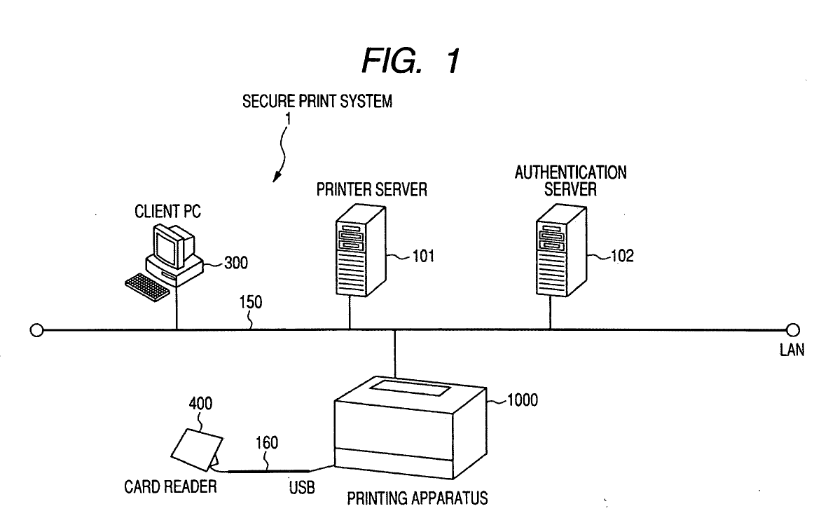

FIG. 1 is a figure illustrating an example of the configuration of the secure print system. As illustrated in FIG. 1, for example, connected via a LAN (Local Area Network) 150 are: one or multiple printing apparatuses 1000 installed in each floor; one or multiple client PCs 300 installed in such a manner that one set for an administrator and one set for each user; one or multiple printer servers 101 installed in each site; and one or multiple authentication servers 102 installed in each site. In addition, the printing apparatus 1000 has a card reader 400 connected via a USB cable 160.

The client PC 300 is a PC for configuring settings of the printing apparatus 1000. The client PC 300 is a PC equipped with a function to be able to communicate with the printing apparatus 1000 via a LAN 150 through HTTP (Hyper Text Transfer Protocol) and TCP/IP (Transmission Control Protocol/Internet Protocol). In addition, the client PC 300 is a PC for introducing a print job from the user. When the user causes an application running on the client PC 300 to generate the print job through the printer driver, the printer driver can transmit the print job to the printing apparatus 1000 and a printer server 101, using a printing protocol such as LPR (Line PRinter daemon protocol).

The printer server 101 receives the print job from the client PC 300, analyzes the print job to obtain job information, and stores the print job. In addition, the printer server 101 receives the print request from the printing apparatus 1000, searches the stored jobs for the job of the user based on the user name included in the print request, and gives the print instruction of the job of the found user to the printing apparatus 1000.

The authentication server 102 is a server for allowing the printing apparatus 1000 to perform the user authentication. The authentication server 102 has data such as user name, mail address, and usage permission associated with a card ID 211. In response to an inquiry from the printing apparatus 1000, the authentication server 102 has a function to reply whether there exists the user and the user information thereof in a case where the user exists.

The card reader 400 is connected with the printing apparatus 1000 via the USB cable 160. When an IC card 410 (for example, FeliCa (registered trademark) of Sony (registered trademark) Corporation) is held over the card reader 400, the card reader 400 reads information in the card, and notifies the information to the printing apparatus 1000 via the USB cable 160.

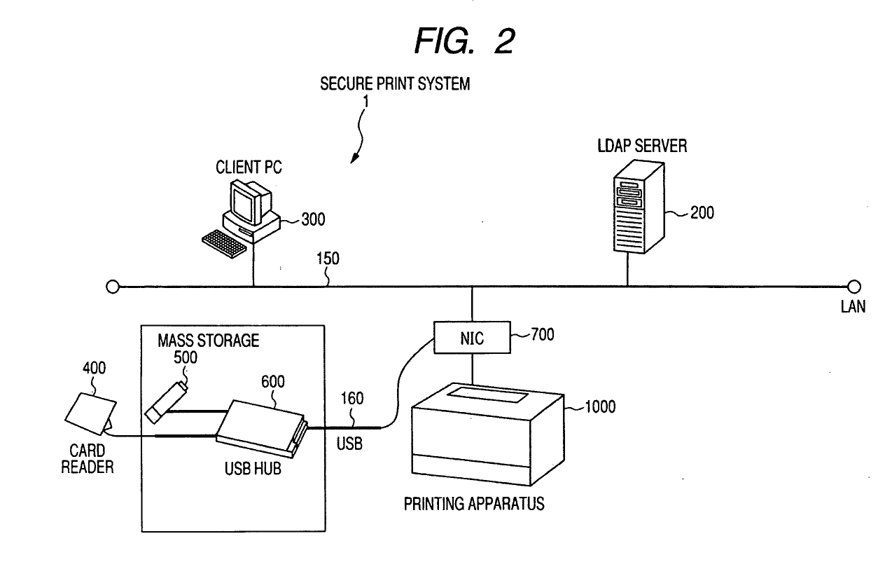

Next, the secure print system 1 according to the present embodiment will be described with reference to FIG. 2. FIG. 2 is a figure illustrating an example of the configuration of the secure print system 1 according to the present embodiment.

The secure print system 1 illustrated in FIG. 2 has the client PC (information processing apparatus) 300, an LDAP (Lightweight Directory Access Protocol) server (authentication server) 200, and a NIC (network interface apparatus) 700, which are connected via the LAN 150. A NIC (network interface apparatus) 700 is inserted into the printing apparatus 1000.

The NIC 700 is connected with a mass storage (memory unit) 500 and the card reader 400 via the USB cable 160 and a USB hub 600. Although the mass storage 500 and the USB hub 600 are externally attached to the printing apparatus 1000 via the NIC 700, the mass storage 500 and the USB hub 600 may also be mounted within the printing apparatus 1000. In a case where the NIC 700 has multiple USB ports 160, it is not necessary to go through the USB hub 600, and instead the card reader 400 and the mass storage 500 are directly connected to the NIC 700.

The LDAP server 200 plays a role of the authentication server 102 of FIG. 1, and has a function to communicate through the LDAP protocol. The LDAP server 200 can centrally manage the user information in a directory therein. The LDAP server 200 may be made up with only one server. Alternatively, the LDAP server 200 may be made up with two servers, i.e., primary and secondary, as described later. Alternatively, the LDAP server 200 may be made up with three or more servers. In any case, it is assumed that the LDAP servers 200 are down means that all of the servers making up the LDAP server 200 are down.

Although the LDAP server 200 is used in FIG. 2, it is not limited to the LDAP server as long as it is a server capable of performing authentication. The client PC 300 is an information processing apparatus that generates the print data. The mass storage 500 is hardware that has a large-capacity file system such as an HDD (Hard Disk Drive) and a flash memory, and is connected to the USB hub 600 via the USB cable 160. The mass storage 500 allows the printing apparatus 1000 to perform controls on the file system, e.g., writing, reading and deleting files.

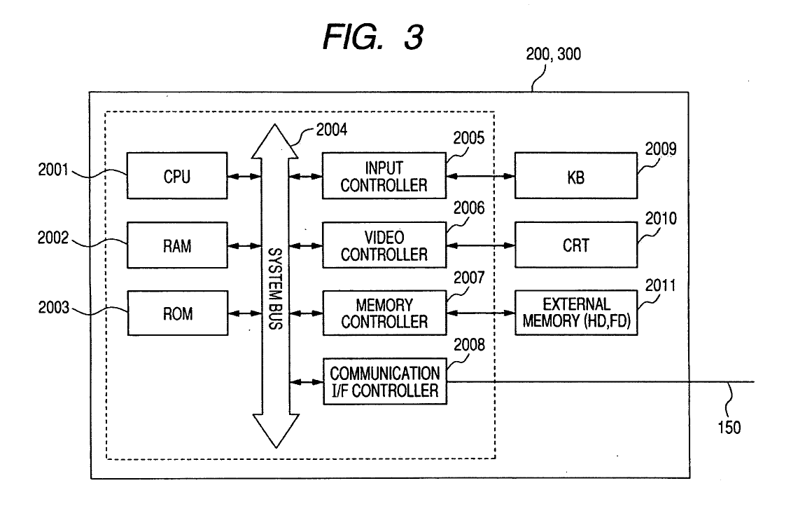

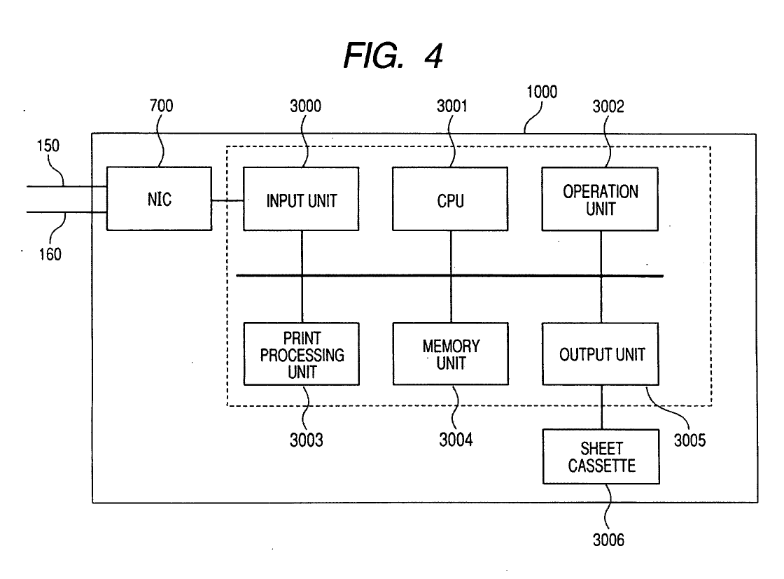

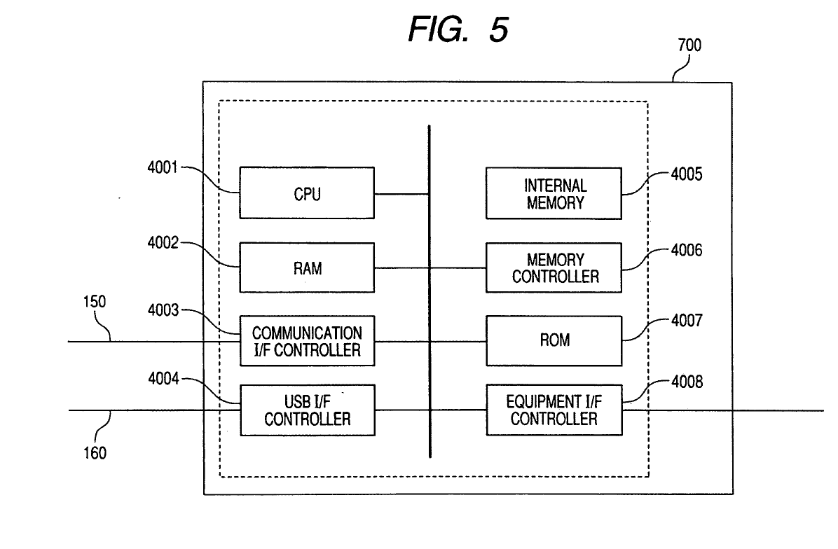

Next, the client PC 300, the LDAP server 200, the printing apparatus 1000, and the NIC 700 will be described with references to FIGS. 3, 4 and 5. FIG. 3 is a figure illustrating the hardware configuration of the LDAP server 200 and the client PC 300. FIG. 4 is a figure illustrating the hardware configuration of the printing apparatus 1000. FIG. 5 is a figure illustrating the hardware configuration of the NIC 700.

As shown in FIG. 3, the LDAP server 200 and the client PC 300 have a CPU (Central Processing Unit) 2001, a RAM (Random Access Memory) 2002, a ROM (Read Only Memory) 2003, an input controller 2005, a video controller 2006, a memory controller 2007, and a communication I/F controller 2008, which are connected via a system bus 2004.

The CPU 2001 centrally controls each device and controllers connected to the system bus 2004. The ROM 2003 or an external memory 2011 stores a BIOS (Basic Input/Output System) which is a control program of the CPU 2001, an OS (Operating System), and various programs executed by each server or each PC. The RAM 2002 functions as a main memory and a work area for the CPU 2001. The CPU 2001 loads programs needed to execute processings from the ROM 2003 or the external memory 2011 to the RAM 2002, and realizes various operations by executing the loaded programs.

The input controller 2005 controls the input from a pointing device such as a keyboard (KB) 2009 and a mouse (not shown). The video controller 2006 controls display on a display apparatus such as a CRT (Cathode Ray Tube) 2010. The display apparatus is not limited to the CRT, and may also be other display apparatuses such as liquid crystal display. These are used by the administrator as necessary.

The memory controller 2007 controls access to the external memory 2011 such as a hard disk (HD), a flexible disk (FD), and a CompactFlash (registered trademark) memory connected to a PCMCIA (Personal Computer Memory Card International Association) card slot via an adapter, which stores a boot program, various applications, font data, user files, edited files, and various data. The communication I/F controller 2008 connects to and communicates with external equipment via a network such as the LAN 150 to execute communication control processings on the network. The communication I/F controller 2008 is capable of communication using, for example, TCP/IP (Transmission Control Protocol/Internet Protocol).

The CPU 2001 can display on the CRT 2010 by executing an expansion (rasterization) processing of outline font to a display information area in the RAM 2002. In addition, the CPU 2001 allows user instructions with a mouse cursor (not shown) on the CRT 2010. Various programs operating on the hardware of the LDAP server 200 and the client PC 300 are recorded in the external memory 2011, and as necessary are loaded to the RAM 2002 and executed by the CPU 2001. Definition files and various information tables used during execution of the programs are stored in the external memory 2011.

Next, the hardware configuration of the printing apparatus 1000 will be described. As illustrated in FIG. 4, the printing apparatus 1000 has an input unit 3000, a CPU 3001, an operation unit 3002, a print processing unit 3003, a memory unit 3004, an output cassette 3005, and a sheet cassette 3006. The input unit 3000 connects between this printing apparatus and the NIC 700, and controls data communication with the NIC 700. The CPU 3001 controls the operation of the entire printing apparatus 1000.

The operation unit 3002 provides the printing apparatus 1000 with an interface for operation directly performed by the user. The print processing unit 3003 analyzes a command received by the input unit 3000 and analyzes the print data (PDL). The memory unit 3004 includes a ROM (not shown) for allowing the printing apparatus 1000 to operate, a RAM (not shown), and a secondary storage apparatus (not shown). The RAM is a data memory area without any usage limitation, and is used for a receive buffer of the input unit 3000 or data expansion of the print processing unit 3003. The output unit 3005 transfers to paper the print data that has been received by the input unit 3000 and has been expanded into image information printable by the print processing unit 3003. The sheet cassette 3006 supplies an appropriate sheet according to the processing of the output unit 3005.

The NIC 700 is a network interface card. On behalf of the printing apparatus 1000, the NIC 700 obtains the data received from other equipment via the LAN 150, and transfers the data to a program (not shown) in the NIC and the input unit 3000 of the printing apparatus 1000.

Next, the hardware configuration of the NIC 700 will be described. As illustrated in FIG. 5, the NIC 700 has a CPU 4001, a RAM 4002, a communication I/F controller 4003, a USB I/F controller 4004, an internal memory 4005, a memory controller 4006, a ROM 4007, and an equipment I/F controller 4008.

The CPU 4001 controls the NIC 700, and controls internally-connected devices. The RAM 4002 functions as a main memory and a work area for the CPU 4001. The CPU 4001 loads programs needed to execute processings from the ROM 4007 or the internal memory 4005 to the RAM 4002, and executes the loaded programs. The communication I/F controller 4003 connects to and communicates with external equipment via a network such as the LAN 150 to execute communication control processings on the network. The communication I/F controller 4003 is capable of communication using communication protocol, for example, TCP/IP and UDP (User Datagram Protocol).

The USB I/F controller 4004 allows the NIC 700 to connect to and communicate with USB equipment such as the card reader 400, the mass storage 500 and the USB hub 600, and executes communication control processings of the USB. The internal memory 4005 stores an OS for controlling the NIC 700, and stores application programs operating on the OS and setting information thereof. The memory controller 4006 controls access to the internal memory 4005 storing various applications and various data. The ROM 4007 is a read-only semiconductor memory, and stores a boot program because the content is not erased even when the power is turned off. The equipment I/F controller 4008 connects and allows communication between the NIC 700 and the printing apparatus 1000.

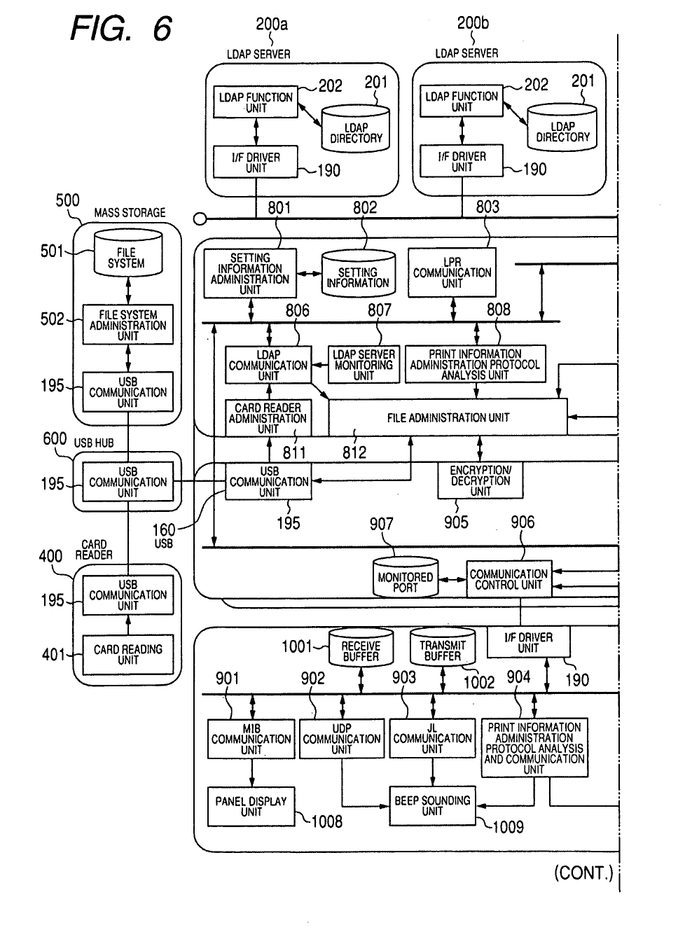

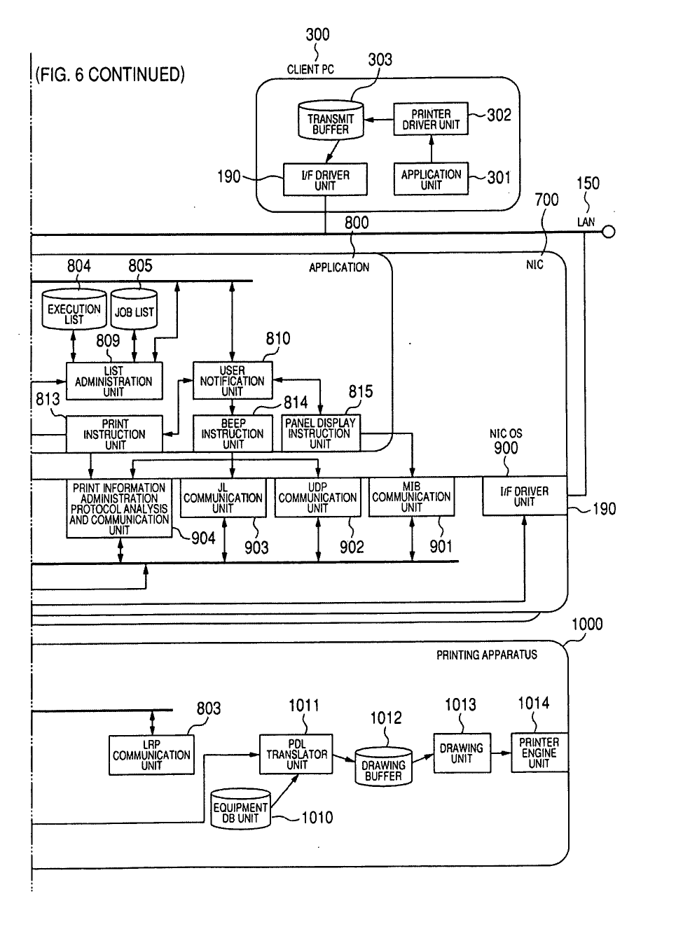

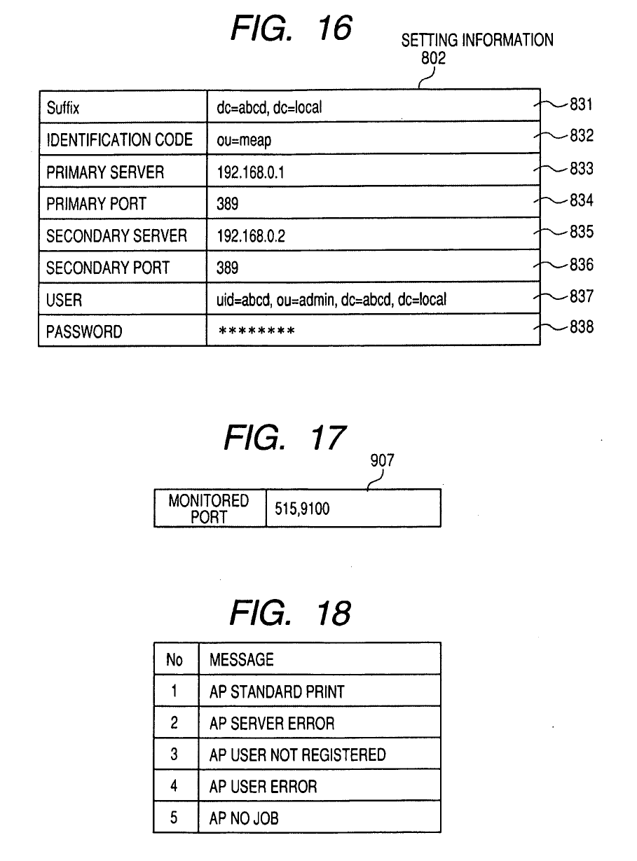

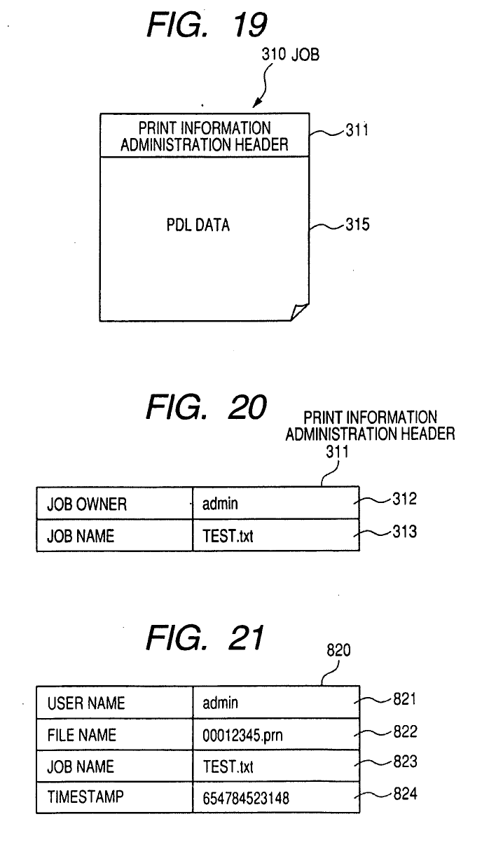

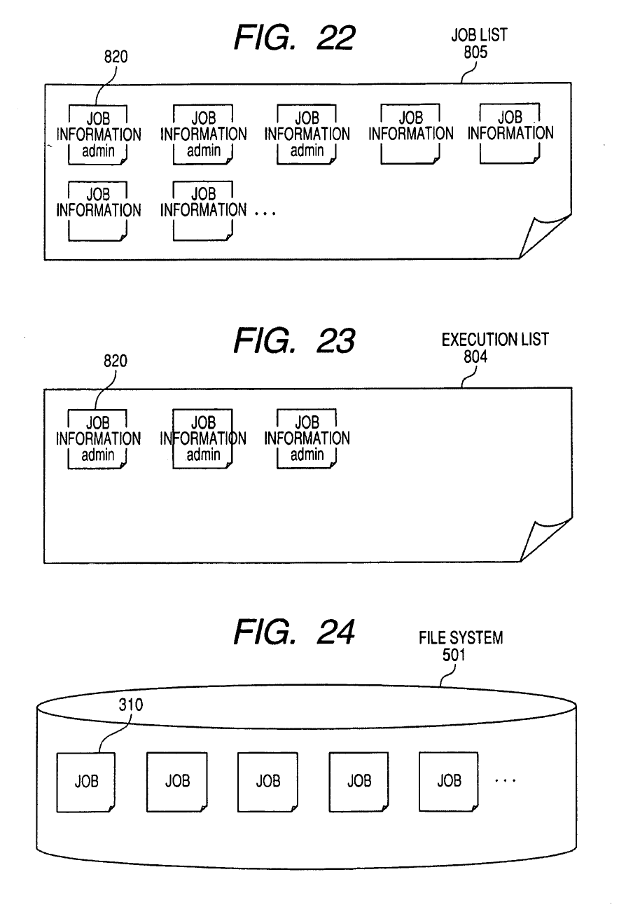

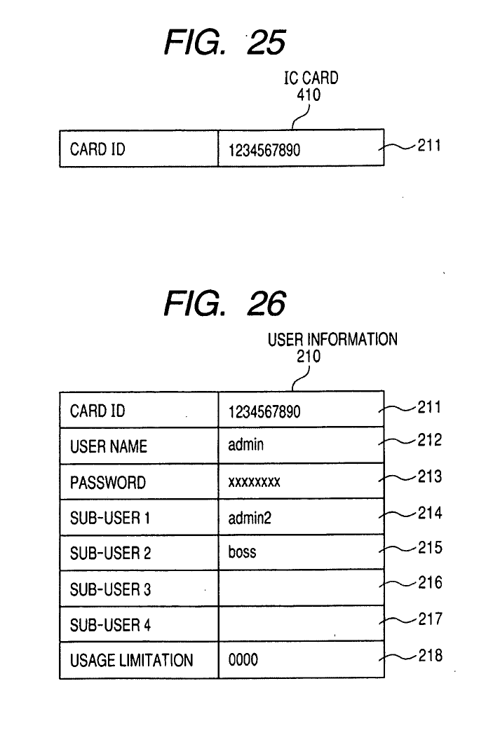

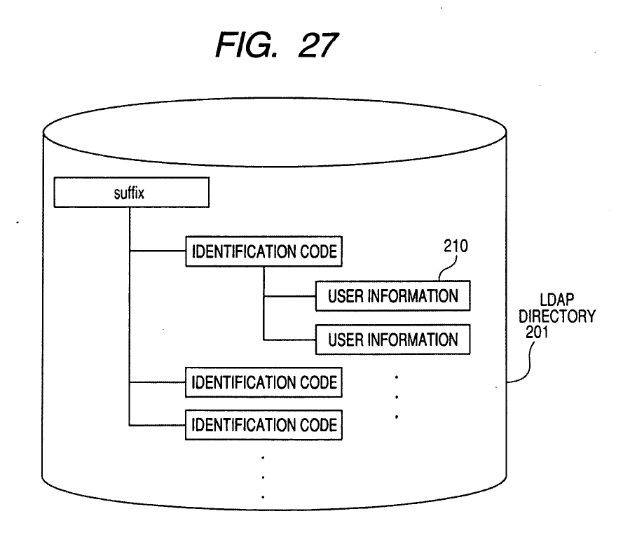

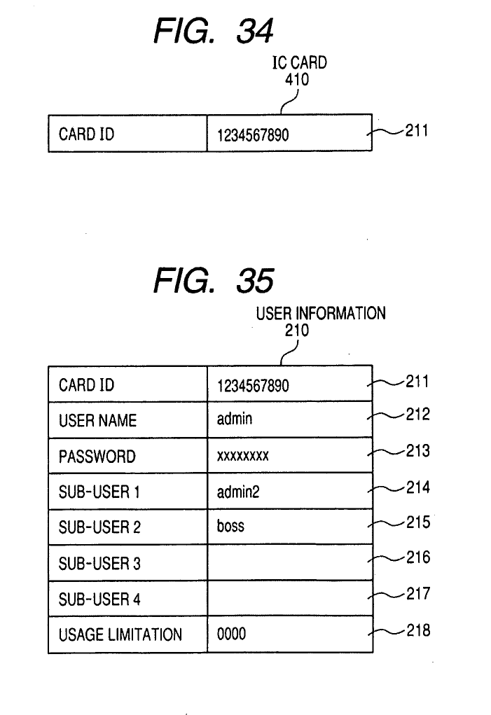

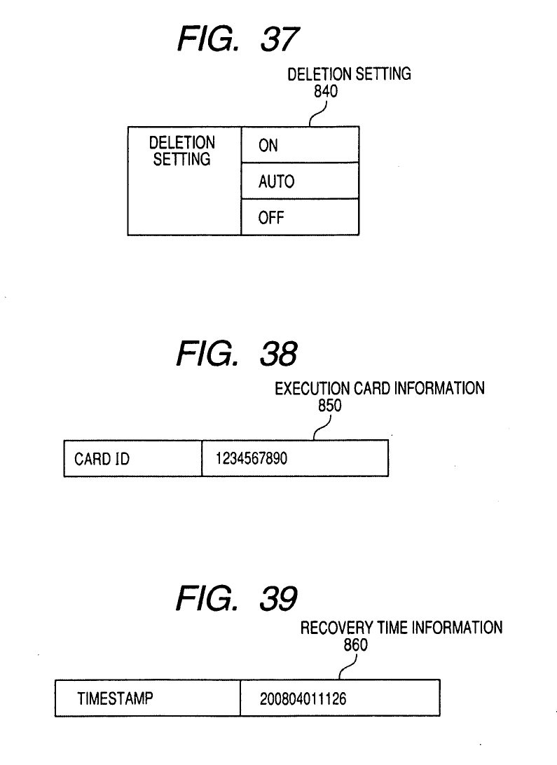

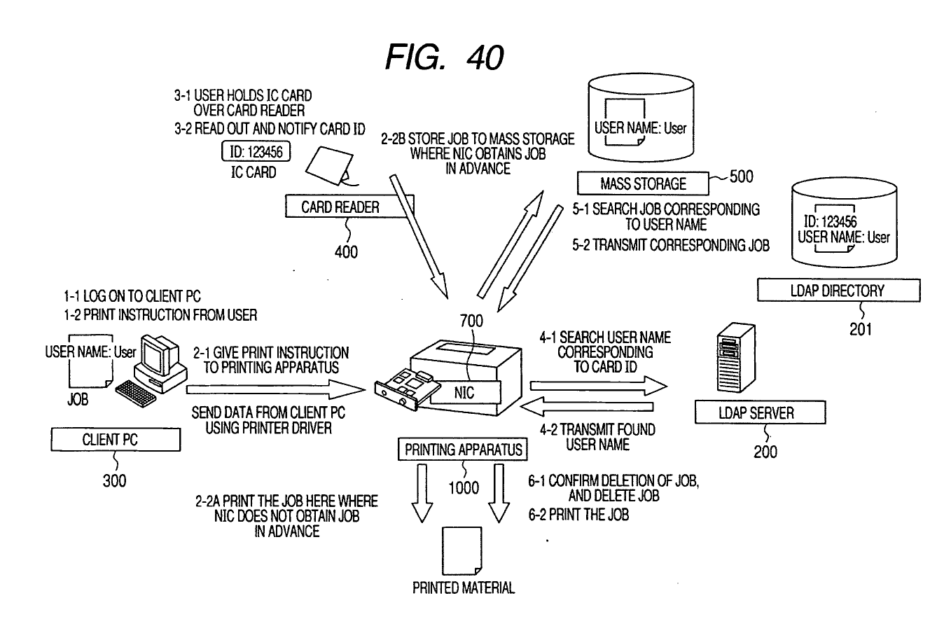

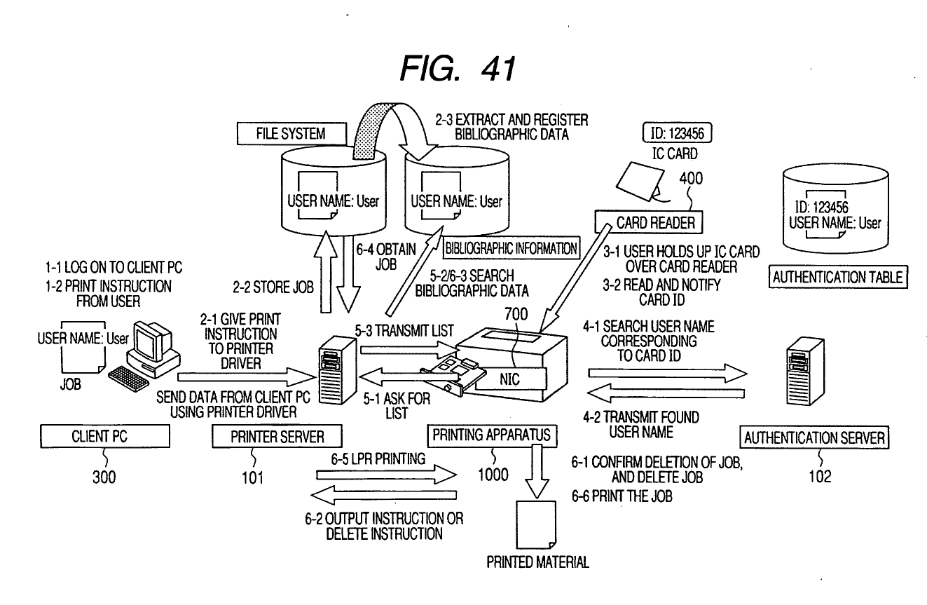

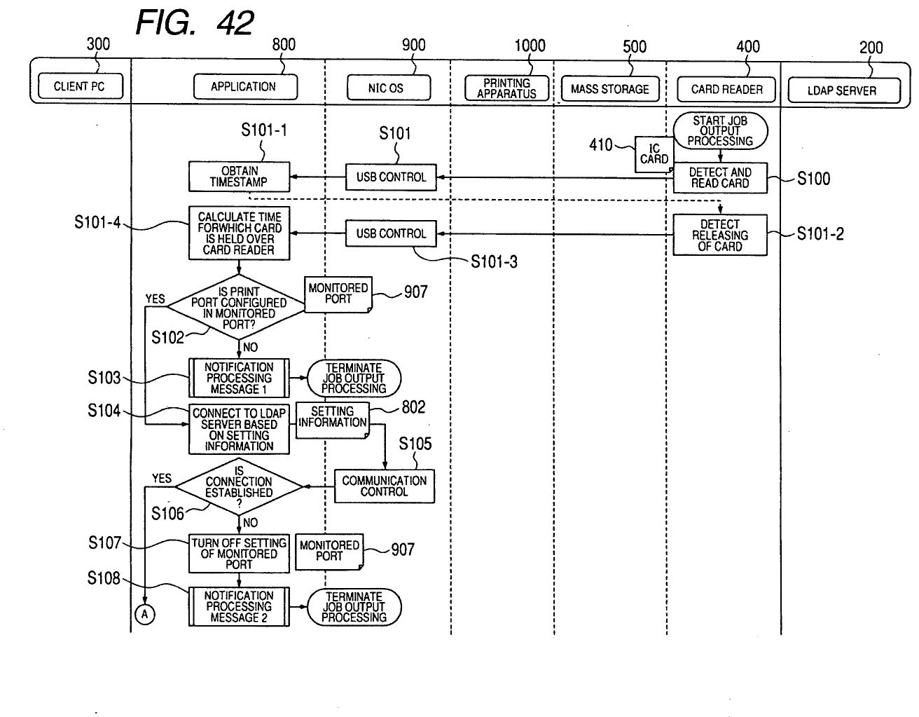

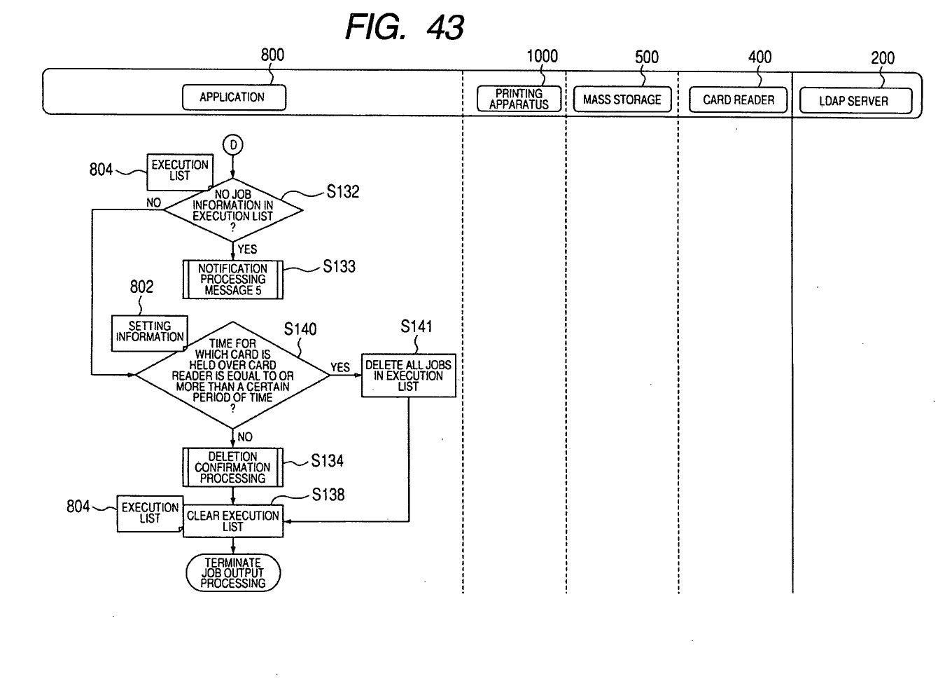

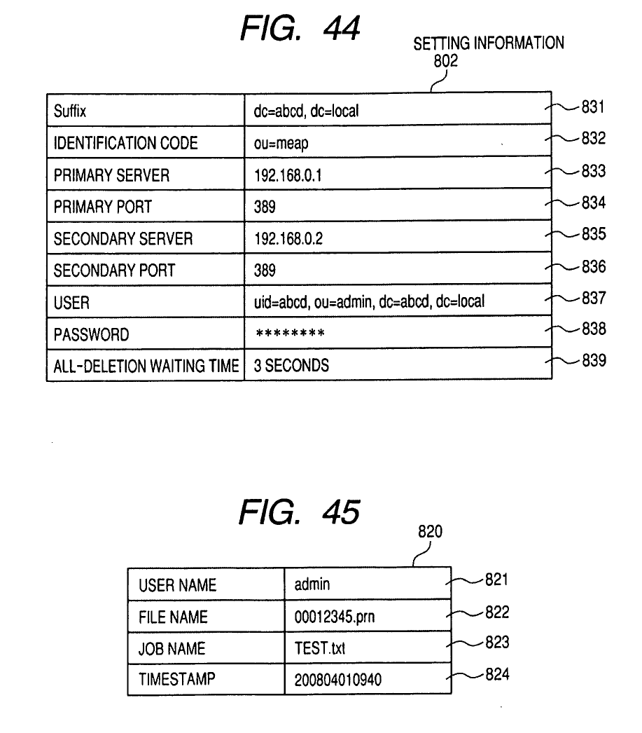

Next, the overall processing flow of the secure print system 1 will be described with reference to FIG. 6, FIG. 16, FIG. 17, FIG. 19, FIG. 20, FIG. 21, FIG. 22, FIG. 23, FIG. 24, FIG. 25, FIG. 26, FIG. 27, FIG. 34, FIG. 35, FIG. 37, FIG. 38, FIG. 39, FIG. 40, FIG. 41, FIG. 42, FIG. 43, FIG. 44, FIG. 45.

FIG. 6 is a block diagram illustrating the configuration of the secure print system 1 according to the present embodiment. FIG. 16 is a figure illustrating an example of setting information 802. FIG. 17 is a figure illustrating the details of a monitored port 907. FIG. 19 is a figure illustrating the details of a job 310. FIG. 20 is a figure illustrating the details of a print information administration header 311. FIG. 21 is a figure illustrating the details of job information 820. FIG. 22 is a figure illustrating the details of a job list 805. FIG. 23 is a figure illustrating the details of an execution list 804. FIG. 24 is a figure illustrating the details of a file system 501. FIG. 25 is a figure illustrating the details of an IC card 410. FIG. 26 is a figure illustrating an example of user information 210. FIG. 27 is a figure illustrating the details of an LDAP directory.

In the secure print system 1, the LDAP server 200, the client PC 300, and the NIC 700 connected to the printing apparatus 1000 are connected via the bidirectionally-communicable LAN 150. The mass storage 500, the USB hub 600 and the card reader 400 are connected to the NIC 700 via the USB cable 160 capable of USB communication.

The LDAP server 200 has an LDAP directory 201, an LDAP function unit 202 and an I/F driver unit 190. The LDAP server 200 may be made in a redundant configuration, and multiple sets of LDAP servers 200 may be installed. The LDAP server 200 plays a role to search user information in the system, and is thus not limited to the LDAP server as long as it is a server that has storing and search function of the user information.

The LDAP directory 201 stores data as illustrated in FIG. 27. The LDAP directory 201 has one or multiple identification codes arranged under Suffix, i.e., the highest unit gathering a group of data, and has one or multiple pieces of user information 210 stored under these identification codes.

Generally, the identification code is made up with the OU (Organization Unit). In Active Directory (registered trademark), Suffix corresponds to a unit called domain.

As illustrated in FIG. 26, the user information 210 has a card ID 211, a user-name 212, a password 213, a sub-user 1 (214), a sub-user 2 (215), a sub-user 3 (216), a sub-user 4 (217) and a usage limitation 218.

As illustrated in FIG. 25, the card ID 211 registers an ID of the IC card 410 of the user, and is a value unique within Suffix. The user name 212 is the name of the user possessing the IC card 410 corresponding to the card ID 211. The password 213 is stored to identify the user when the user authentication is performed. The sub-users 1 (214) to 4 (217) are aliases of the user name 212 mainly used by the user, and are user names used in a case where the user acts on behalf of another user. The usage limitation 218 stores limitation information on the usage of the printing apparatus 1000.

The LDAP function unit 202 performs connection of communication, authentication, search, modification, addition, deletion, disconnection according to the LDAP protocol. In the connection, the LDAP function unit 202 secures a logical communication path for a client that has issued a connection request. In the authentication, the LDAP function unit 202 searches the LDAP directory 201 for the user name that has issued the connection request, performs password verification, and replies the authentication result. In the search, the LDAP function unit 202 searches the LDAP directory 201 for the corresponding user based on the value specified by a search request, and replies the corresponding user information 210.

The I/F driver unit 190 connects to and communicates with external equipment via a network such as the LAN 150, and controls communication according to the communication protocol such as TCP/IP and UDP.

The client PC 300 has an application unit 301, a printer driver unit 302, a transmission buffer 303, and an I/F driver unit 190. The application unit 301 provides graphical user interface to the user, and generates image data appropriate for the purpose of the user. The printer driver unit 302 converts the image data generated by the application unit 301 into page description language (PDL) data printable by the printing apparatus 1000. Furthermore, the printer driver unit 302 attaches to the PDL data the print information administration header 311 including job information such as a job owner 312 and a job name 313 as illustrated in FIG. 20 to generate the job 310 as illustrated in FIG. 19. The transmission buffer 303 realizes storing by temporarily storing the job 310 generated by the printer driver unit 302.

The USB hub 600 has the USB communication unit 195. The USB hub 600 relays the USB data, and transfers the USB data of the equipment connected to the USB hub 600 to each of other equipment. The USB communication unit 195 performs data communication such as control transfer, interrupt transfer, bulk transfer, and isochronous transfer according to the USB specification. Transferring data is a necessary condition, and thus the transfer speed and the USB version do not matter.

The mass storage 500 has a file system 501, a file system administration unit 502, and a USB communication unit 195. As illustrated in FIG. 24, the file system 501 stores the job 310 in the internal storage apparatus (not shown). Furthermore, the file system 501 writes, reads, and deletes the job 310.

The card reader 400 has the USB communication unit 195 and a card reading unit 401. The card reading unit 401 reads the card ID 211 from the IC card 410. When the IC card 410 is held over the card reader 400, the card reading unit 401 reads information such as the card ID 211 from the IC card 410, and transmits the information to other equipment connected via the USB communication unit 195.

The NIC 700 has an application 800 and a NIC OS 900. The application 800 is a program operating on the NIC OS 900. The NIC OS 900 controls the NIC 700, and at the same time, administers the application 800 on the NIC 700 and gives various instructions to the printing apparatus 1000.

The application 800 of the NIC 700 has a setting information administration unit 801, a setting information 802, an LPR communication unit 803, an execution list 804, a job list 805, an LDAP communication unit 806, an LDAP server monitoring unit 807, a print information administration protocol analysis unit 808, a list administration unit 809, a user notification unit 810, a card reader administration unit 811, a file administration unit 812, a print instruction unit 813, a beep instruction unit 814 and a panel display instruction unit 815.

The setting information administration unit 801 administers the setting information 802 needed to execute the application 800 illustrated in FIG. 16, and writes and reads the setting information 802. When the client PC 300 accesses the application 800 using a browser to configure the setting information of the application 800 and the application 800 receives an instruction from the client PC 300, the setting information administration unit 801 stores the configured data as the setting information 802. The setting information 802 has a suffix 831, an identification code 832, a primary server 833, a primary port 834, a secondary server 835, a secondary port 836, a user 837 and a password 838.

The suffix 831 and the identification code 832 are conditions with which a search location is specified when the search request is issued to the LDAP server 200. The primary server 833, the primary port 834, the secondary server 835, and the secondary port 836 are information with which the connection to the LDAP server 200 is established. Because the LDAP server 200 may be made in a redundant configuration, multiple sets of LDAP servers 200 such as primary and secondary can be configured. The user 837 and the password 838 are information needed to issue the authentication request to the LDAP server 200.

The LPR communication unit 803 communicates upon analyzing the LPR print protocol. Namely, the LPR communication unit 803 communicates upon analyzing the protocol through which the job 310 is received from the client PC 300. Herein, the LPR is noted as an example, but the protocol is not especially limited to the LPR as long as it is a printing protocol.

The execution list 804 is as illustrated in FIG. 23, and is a subset of the job list 805 illustrated in FIG. 22. When executing printing, the print instruction is given based on the job information 310 stored in the execution list 804. The job list 805 is made up with the job information 820 illustrated in FIG. 21. The job information 820 is extracted information needed to administer the job 310, and has a user name 821, a file name 822, a job name 823 and a timestamp 824. The job list 805 stores all the information of the job 310 stored in the file system 501.

The LDAP communication unit 806 communicates with the LDAP server 200 according to the LDAP protocol, and connects to the LDAP server 200 specified by the primary server and the primary port in the setting information 802. The LDAP communication unit 806 performs authentication using the user 837 and the password 838 in the setting information 802. In addition, the LDAP communication unit 806 searches the user information 210 (FIG. 26) associated with the card ID 211, taking the suffix 831 and the identification code 832 in the setting information 802 as the search location. In a case where neither the primary nor the secondary can be accessed, the designation of a print port in the monitored port 907 is canceled.

The LDAP server monitoring unit 807 periodically monitors whether the LDAP server 200 and the NIC 700 are in a state capable of communicating with each other. Actual connection processings are performed through the LDAP communication unit 806. During the monitoring processing, in a case where it is determined that the LDAP server 200 and the NIC 700 can communicate with each other and where the print port is not configured in the monitored port 907, the print port is added to the monitored port 907. Thus, the recovery of the print switching when the server is down is realized.

The print information administration protocol analysis unit 808 analyzes the print information administration header 311 included in the job 310. The print information administration header 311 is binary data attached to the head of the PDL data, and includes various job information. The job owner 312 and the job name 313 included in the print information administration header 311 are obtained, and a value analyzed by the print information administration protocol analysis unit 808 is used when the job information 820 is generated.

The list administration unit 809 administers the execution list 804 and the job list 805. When the job 310 is written to the file system 501, the list administration unit 809 receives the job information 820 from the file administration unit 812, and adds the job information 820 to the job list 805 to manage the job list 805. In addition, the list administration unit 809 extracts from the job list 805 the job information 820 corresponding to the user name given by the LDAP communication unit 806 to generate the execution list 804. Upon receiving a notification from the file administration unit 812 when printing is completed, the list administration unit 809 deletes the corresponding job information 820 from the job list 805.

The user notification unit 810 notifies an error to the user who uses the printing apparatus 1000. The user notification unit 810 has such functions as: appealing to the acoustic sense of the user by giving a beep instruction to the NIC OS 900 to cause the printing apparatus 1000 to produce the beep sound; and appealing to the visual sense of the user by giving a panel display instruction to cause the panel of the printing apparatus 1000 to display an arbitrary text.

The card reader administration unit 811 controls the card reader 400 connected to the NIC 700 via the USB 160. When the IC card 410 is held over the card reader 400, the card reader administration unit 811 obtains the card ID 211.

The file administration unit 812 administers the job 310 within the application 800. The file administration unit 812 stores the job 310 to the file system 501 upon encrypting the job 310, decrypts the job 310, sends the job 310 to the print instruction unit 813, and deletes the corresponding job 310 from the file system 501 at a time when the job has been finished being introduced to the print instruction unit 813.

The print instruction unit 813 gives the print instruction of the decrypted job 310, having been sent from the file administration unit 812, to the NIC OS 900 using the print information administration protocol.

The beep instruction unit 814 receives the beep instruction from the user notification unit 810, and notifies the NIC OS 900. Regarding the beep sound, the producing of the beep can be realized with various methods such as using the print information administration protocol, the JL, and the UDP, but it depends on the printing apparatus 1000 which function is supported. The beep instruction unit 814 gives an appropriate beep instruction by absorbing the difference of the type of the printing apparatus 1000.

The panel display instruction unit 815 uses an MIB (Management Information Base) to cause the panel (not shown) of the printing apparatus 1000 to display an arbitrary message. In a case where the printing apparatus 1000 is of a model that cannot display for a certain period of time, the panel display instruction unit 815 resets the display upon displaying for several seconds.

Next, the details of the NIC OS 900 will be described. The NIC OS 900 has an I/F driver unit 190, a USB communication unit 195, a encryption/decryption unit 905, a print information administration protocol analysis and communication unit 904, a JL communication unit 903, a UDP communication unit 902, an MIB communication unit 901, a communication control unit 906 and a monitored port 907.

The encryption/decryption unit 905 performs encryption and decryption of data. The encryption/decryption unit 905 is not limited to a fixed type, but can perform block encryption, e.g., DES (Data Encryption Standard), Triple DES, and AES (Advanced Encryption Standard) and stream encryption, e.g., RC4. The print information administration protocol analysis and communication unit 904 performs data communication according to the print information administration protocol. The print information administration protocol is a communication protocol for controlling the printing apparatus 1000, and can give the print instruction and produce the beep sound. The JL communication unit 903 performs JL communication. The JL is a job control language, and can give an information acquisition instruction of the printing apparatus 1000, a reception instruction of the PDL data, and the beep instruction to the printing apparatus 1000.

The UDP communication unit 902 performs UDP communication. With the use of this UDP communication, the DNS (Domain Name System) query and the beep instruction can be performed. The MIB communication unit 901 performs MIB communication. The MIB is a protocol for administering communication equipment, and performs displaying on the panel of the printing apparatus 1000. The communication control unit 906 notifies the application 800 of data received from the I/F driver unit 190, and transmits the data to the printing apparatus 1000. In a case where the data is sent to a port that is configured in the monitored port 907, the communication control unit 906 notifies the application 800. In a case where the data is received by a port that is not configured in the monitored port 907, the communication control unit 906 transmits the data to the printing apparatus 1000. As illustrated in FIG. 17, the monitored port 907 is information for determining which of the application 800 or the printing apparatus 1000 the communication control unit 906 transmits the data to. The monitored port 907 specifies the communication port number for notifying the application 800.

Next, the printing apparatus 1000 will be described. The printing apparatus 1000 has an I/F driver unit 190, a receive buffer 1001, a transmit buffer 1002, an MIB communication unit 901, a UDP communication unit 902, a JL communication unit 903, a print information administration protocol analysis and communication unit 904, an LPR communication unit 803, a panel display unit 1008, a beep producing unit 1009, a PDL translator unit 1011, an equipment DB unit 1010, a drawing buffer 1012, a drawing unit 1013, and a printer engine unit 1014.

The receive buffer 1001 serves as a buffer material against processing delay by temporarily securing all the data received by the I/F driver unit 190. The transmit buffer 1002 serves as a buffer material against processing delay by temporarily securing all the data prior to be transmitted to the I/F driver unit 190. The panel display unit 1008 displays a specified message on the panel of the printing apparatus 1000. The beep producing unit 1009 activates a sound producing device (not shown) in the printing apparatus 1000 to produce the sound. The equipment DB unit 1010 stores information of the printing apparatus 1000 configured by the JL, and provides the information to the PDL translator unit 1011. The environmental information referred to herein is, for example, the number of prints.

The PDL translator unit 1011 performs a translation processing of the PDL data to convert the PDL data into intermediate data, i.e., a drawing object appropriate for drawing. The drawing buffer 1012 temporarily stores the intermediate data of the drawing object generated by the PDL translator unit 1011 until the printing is actually performed. The drawing unit 1013 actually draws the drawing object temporarily stored in the drawing buffer 1012 to generate image data, i.e., a bitmap image. The printer engine unit 1014 receives the bitmap image generated by the drawing unit 1013, and prints the bitmap image on a medium such as a sheet through a known print technology.

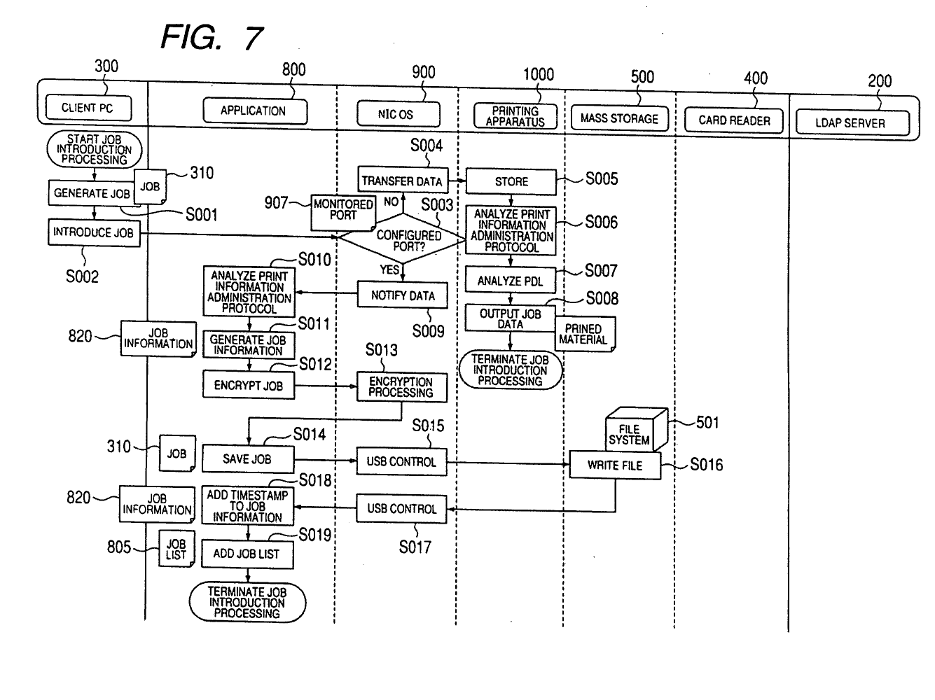

Next, the detailed processings of the secure print system 1 according to the present embodiment will be described with reference to FIGS. 7, 8, 9, 10, 11, 12, 13, 14, 15 and 18.

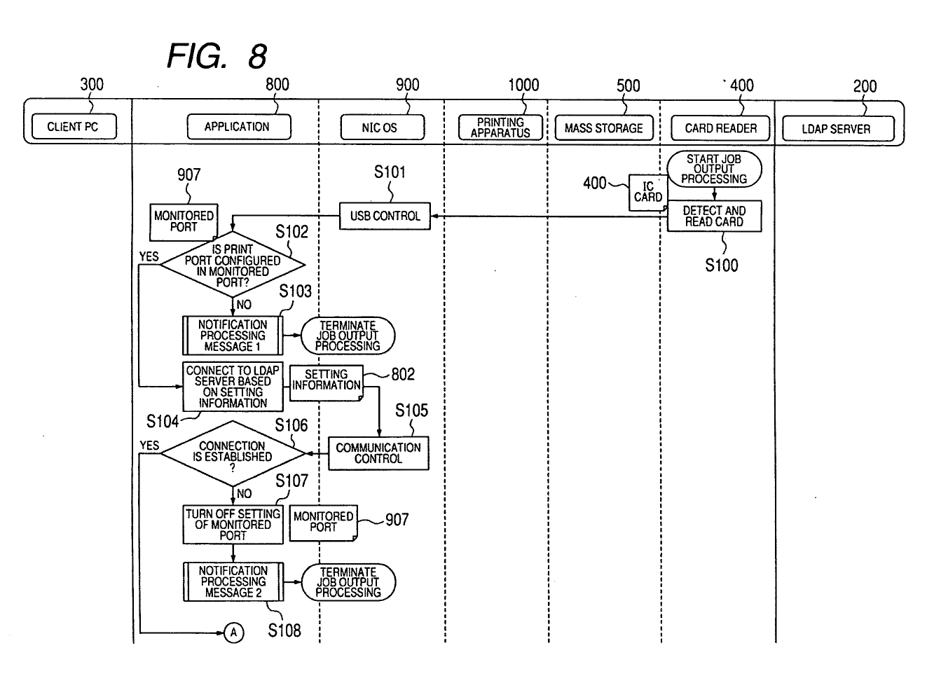

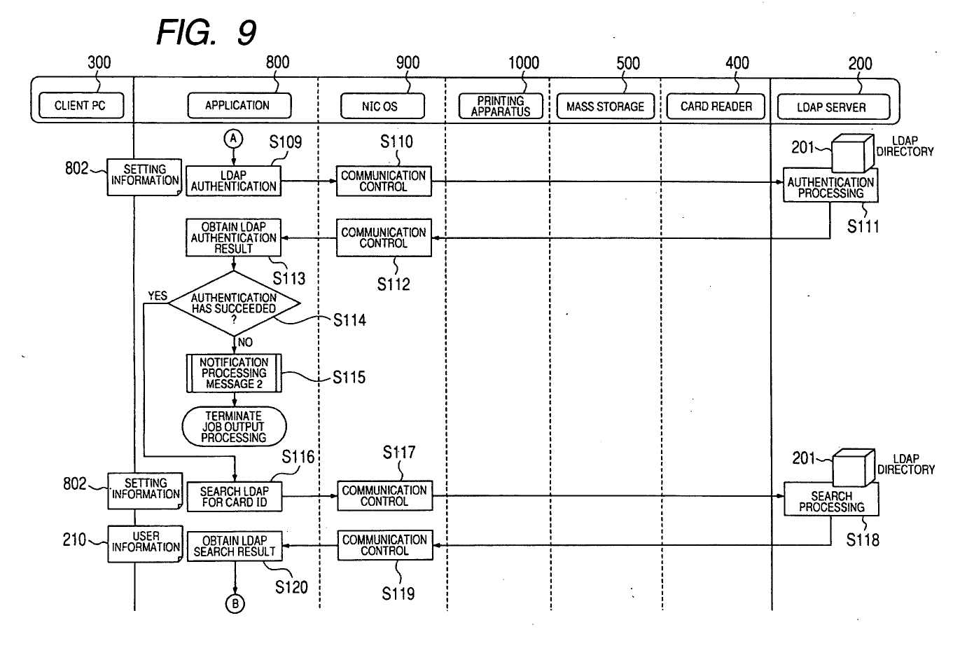

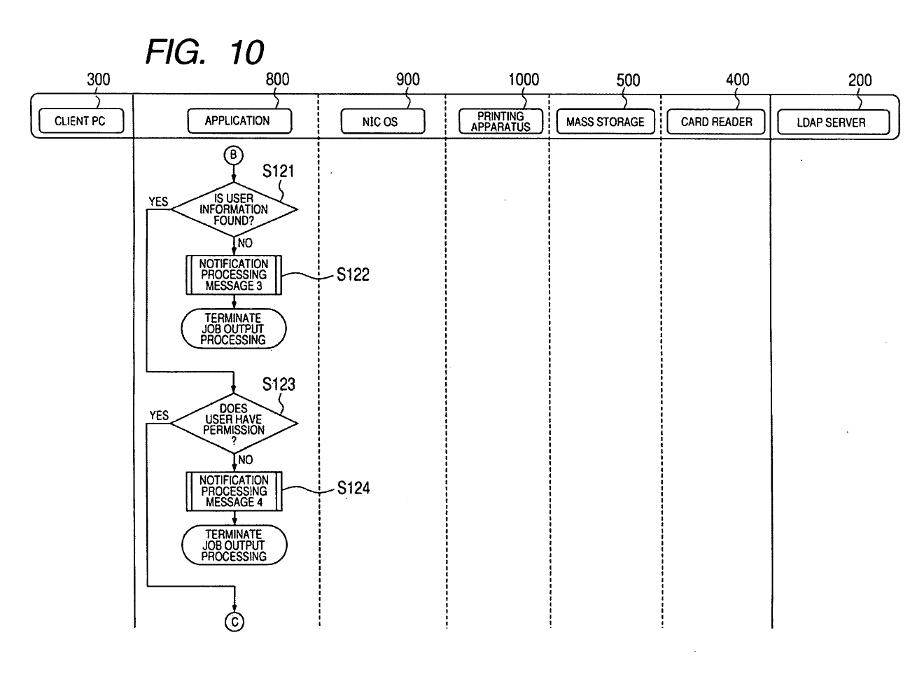

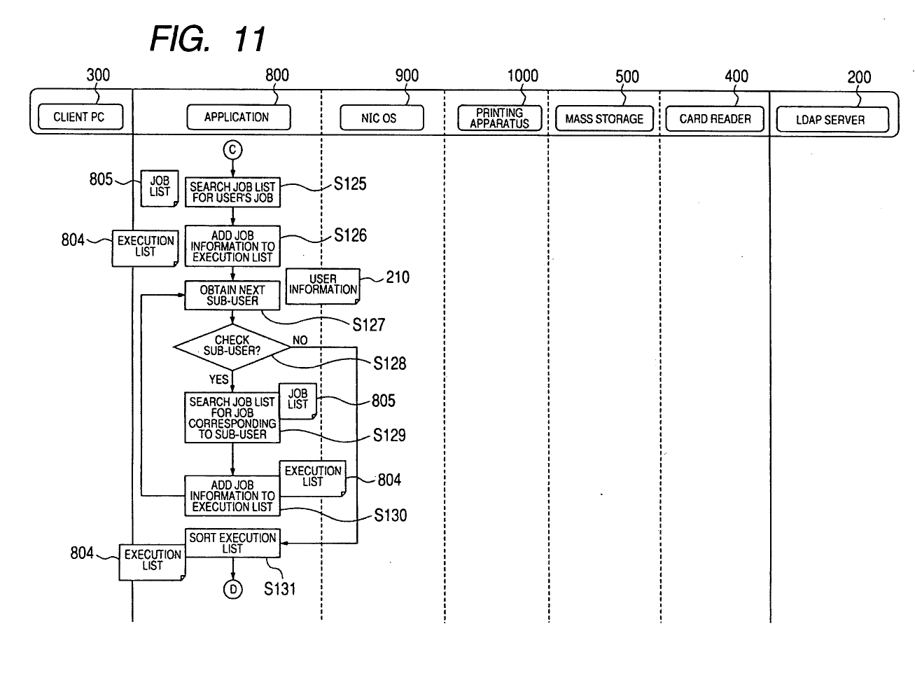

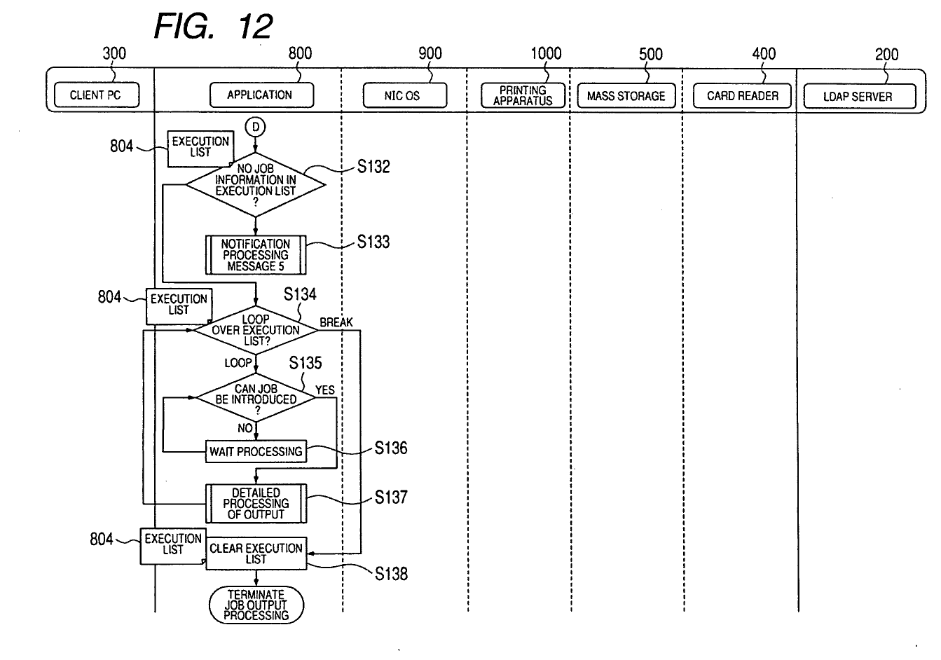

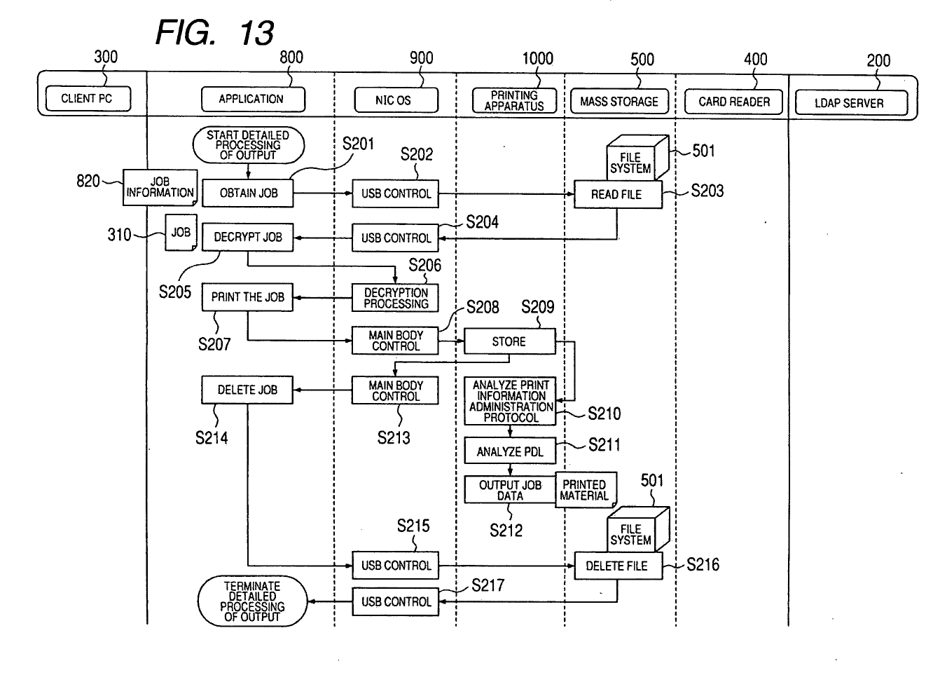

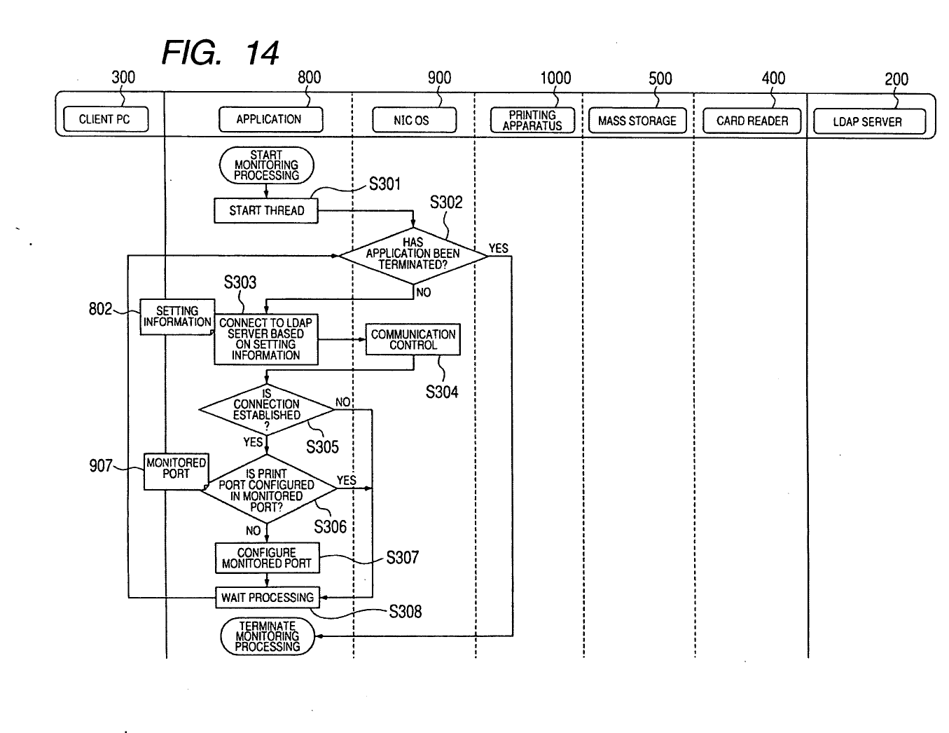

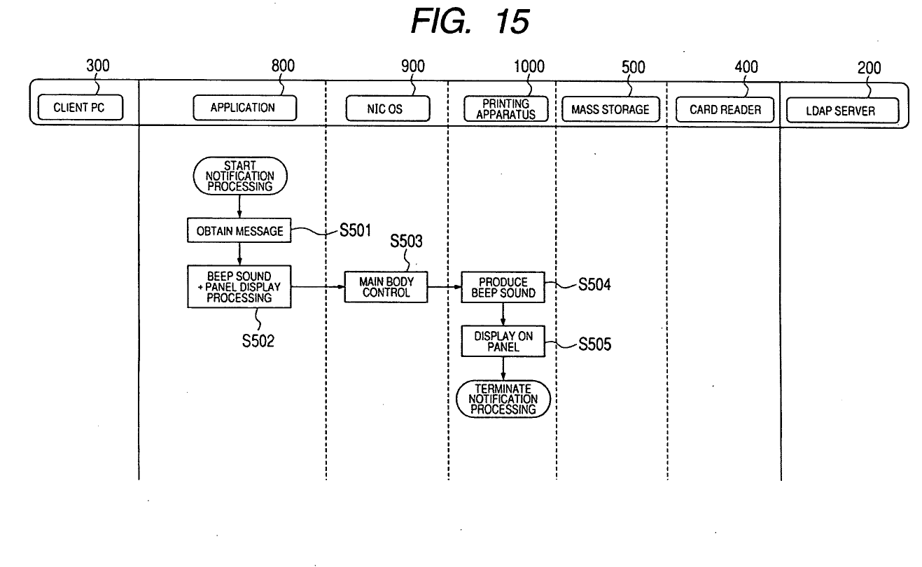

FIG. 7 is a flowchart illustrating an example of a print job introduction processing procedure of the secure print system 1. FIG. 8 is a flowchart illustrating an example of a print job output processing procedure of the secure print system 1. FIG. 9 is a flowchart illustrating an example of the print job output processing procedure of the secure print system 1. FIG. 10 is a flowchart illustrating an example of the print job output processing procedure of the secure print system 1. FIG. 11 is a flowchart illustrating an example of the print job output processing procedure of the secure print system 1. FIG. 12 is a flowchart illustrating an example of the print job output processing procedure of the secure print system 1. FIG. 13 is a flowchart illustrating an example of a detailed procedure of output processing of the secure print system 1. FIG. 14 is a flowchart illustrating an example of an LDAP server monitoring processing procedure of the secure print system 1. FIG. 15 is a flowchart illustrating an example of a user notification processing procedure of the secure print system 1. FIG. 18 is a figure illustrating an example of messages displayed on the printing apparatus 1000.

Hereinbelow, the processings performed by the NIC 700 will be described, distinguishing between the function of the application 800 and the function of the NIC OS 900. Accordingly, it is assumed for the sake of convenience that the subjects of the processings are the application 800 and the NIC OS 900. It should be noted that in reality the subject that performs the processings is the NIC 700. The NIC 700, which is hardware, executes later-described processings by working together with the application 800 or the NIC OS 900, which are software.

In FIG. 7, the NIC 700 receives the print data from the client PC 300. In addition, the NIC 700 stores the received print data to the mass storage 500. In addition, the NIC 700 transmits the print data to the printing apparatus 1000.

As illustrated in FIG. 7, in the processing of introduction of job to the secure print system 1, the application of the client PC 300 generates the job 310 with the printer driver (step S001). When the client PC 300 transmits the generated job 310 to the NIC OS 900 (step S002), the NIC OS 900 receives the data transmitted from the client PC 300 and performs a branch processing upon checking the setting of the monitored port 907 (step S003). It is not necessary for the client PC 300 to be aware of whether the printing method uses the mass storage 500 or directly outputs the print data from the printing apparatus 1000 due to the inability to communicate with the LDAP server 200. The secure print system is realized that saves trouble in changing the settings and has higher usability because during printout the job 310 can be transmitted without being aware of whether the communication with the LDAP server 200 is available or not.

In a case where the data is addressed to a port other than the ports configured in the monitored port 907 to be monitored, the NIC OS 900 transmits the received job 310 to the printing apparatus 1000 (step S004), and the printing apparatus 1000 receives the transmitted job 310, and performs a storing processing by storing the job 310 to the receive buffer 1001 (step S005). The printing apparatus 1000 analyzes the print information administration header 311 of the data of the stored job 310 (step S006). The analyzed data is used for an internal log data, not shown.

The printing apparatus 1000 analyzes the PDL data in the job 310, generates the intermediate data of the drawing object, and further generates the bitmap image based on the intermediate data (step S007). The printing apparatus 1000 prints the generated bitmap image to a medium such as a sheet through a known print technology (step S008).

In a case where the received data is a data addressed to a port configured in the monitored port 907, the NIC OS 900 transmits the job 310 to the application 800 where the received data is a data addressed to a port configured to be monitored (step S009). The application 800 analyzes the print information administration header 311 of the job 310 to obtain the job owner and the job name (step S010), and the application 800 generates the job information 820 (step S011).

The obtained job owner 312 is stored as the user name 821, and the obtained job name 313 is stored as the job name 823. In addition, a text string unique within the application is generated and is made to be the file name 822. The timestamp 824 is stored after the file is written.

The application 800 transmits the data of the job 310 to the NIC OS 900 and specifies an encryption key and an encryption algorithm to encrypt the job 310 (step S012). The NIC OS 900 encrypts the transmitted job data using the specified parameter (step S013). The application 800 writes the job encrypted by the NIC OS 900 to the file system 501 (step S014).

Writing the job 310 to the file system 501 eliminates the necessity to write the job 310 to the printer server 101 as conventionally. Thus, the printer server 101 becomes unnecessary, and the secure print system is realized that is more highly secure. In addition, the fact that the printer server 101 is unnecessary saves the cost of the server installation and saves the trouble in configuring the settings of the server installation during the introduction of the secure print system. Furthermore, in the unlikely event that the mass storage 500 is removed from the printing apparatus 1000, there is no risk for the PDL data in the job 310 to be read out because the job 310 is written encrypted. Thus, high security is realized.

When the NIC OS 900 notifies the mass storage 500 of the processing that the job 310 is saved (step S015), the mass storage 500 writes the encrypted job 310 to the file system 501 (step S016). When the NIC OS 900 notifies the application 800 of the processing that the encrypted job 310 is written to the file system 501 (step S017), the application 800 obtains the timestamp of the time when the job 310 has finished being written to the file system 501, and stores the timestamp to the timestamp 824 of the job information 820 (step S018). The application 800 stores the generated job information 820 to the job list 805 (step S019).

Next, the processing of job output of the secure print system 1 will be described with reference to FIGS. 8, 9, 10, 11 and 12.

In FIG. 8, the NIC 700 transmits the authentication request including the user information 210 to the LDAP server 200. In addition, the NIC 700 makes a determination whether the NIC 700 can communicate with the LDAP server 200. In addition, in a case where the NIC 700 cannot communicate with the LDAP server 200, the NIC 700 turns off a setting of storing the print data to the mass storage 500. In addition, in a case where the NIC 700 can communicate with the authentication server and where the setting of storing the print data to the mass storage 500 is turned off, the NIC 700 turns on that setting again.

As illustrated in FIG. 8, the card reader 400 detects the IC card 410, and reads the card ID 211 recorded in the IC card 410 (step S100), and the NIC OS 900 transmits the read information to the application 800 (step S101).

The application 800 checks the setting of the monitored port 907 to confirm whether the print port (for example, port 9100 in a case of Raw, port 515 in a case of LPR) is configured in the monitored port 907 (step S102). In a case where the print port is not included in the ports to be monitored and where the application 800 cannot communicate with the LDAP server 200, the application 800 performs a user notification processing as illustrated in FIG. 15 upon selecting a message 1 “AP STANDARD PRINT” from among the messages illustrated in FIG. 18 (step S103).

In a case where the print port is configured in the monitored port 907 or where the print port is not included in the ports to be monitored but the application 800 communicates with the LDAP server 200 to find to be able to establish communication therewith, the application 800 adds the print port to the monitored port, and attempts to communicate with the LDAP server 200 based on the setting information 802 (step S104). Specifically, the application 800 refers to the setting information 802 and communicates with the primary, i.e., the primary port of the LDAP server 200a, and if the application 800 cannot communicate therewith, the application 800 communicates with the secondary, i.e., the secondary port of the LDAP server 200b.

The NIC OS 900 attempts to communicate with the LDAP server 200 based on the connection request (step S105), the application 800 performs a branch processing based on whether or not the connection attempt has succeeded (step S106). Specifically, in a case where neither the primary, i.e., the LDAP server 200a, nor the secondary, i.e., the LDAP server 200b, cannot be communicated with, the connection is deemed to have failed. Then, the application 800 cancels the setting of the print port configured in the monitored port 907 (step S107), and performs the user notification processing upon selecting a message 2 “AP SERVER ERROR” from among the messages illustrated in FIG. 18 (step S108). In a case where the LDAP server 200 cannot be communicated with, the job 310 is directly printed from the printing apparatus 1000 without being saved in the mass storage 500 in the next and subsequent prints because the setting of the monitored port 907 is canceled. Thus, the printed materials can be output even in a state where the communication with the LDAP server 200 is unavailable.

Next, in a case where either of the primary, i.e., the LDAP server 200a, or the secondary, i.e., the LDAP server 200b, can be communicated with as illustrated in FIG. 9, the application 800 performs the LDAP authentication (step S109). The authentication request is issued by transmitting the user 837 and the password 838 of the setting information 802 to the LDAP server 200. It should be noted that this authentication processing described here is a processing in a case where a rigid security is enforced, namely, a search is not allowed without the authentication performed by the LDAP server 200. As another embodiment, the processings from S109 to S114 relating to the authentication may be omitted in a case where a setting of not requiring the authentication prior to performing the search (setting of non-authentication) is made.

The NIC OS 900 transmits to the LDAP server 200 the data transmitted from the application 800 (step S110). The LDAP server 200 searches the LDAP directory 201 with the user name of the data transmitted by the NIC 700. In a case where the user is found, the LDAP server 200 verifies the password 213 included in the user information 210 of the user corresponding to the transmitted data, and replies the authentication result (step S111). When the NIC OS 900 transmits the data received from the LDAP server 200 to the application 800 (step S112), the application 800 receives the LDAP authentication result (step S113).

The application 800 performs a branch processing based on whether the authentication result in the foregoing S113 has succeeded or not (step S114), and if the authentication fails, the application 800 performs the user notification processing upon selecting the message 2 “AP SERVER ERROR” from among the messages illustrated in FIG. 18 (step S115). If the authentication succeeds, the application 800 performs the search of the card ID 211 based on the setting information 802 with the LDAP server 200 (step S116). The application 800 specifies the search location using the suffix 831 and the identification code 832 of the setting information 802.

The NIC OS 900 transmits to the LDAP server 200 the data transmitted from the application 800 (step S117). The LDAP server 200 searches the LDAP directory 201 based on the data transmitted from the application 800, and replies the search result (step S118). The LDAP server 200 searches the specified card ID 211 in the data residing under the suffix 831 and the identification code 832 specified, and transmits the found user information 210. The suffix 831 and the identification code 832 are information that is specified to identify the location of the user within the LDAP directory 201, and generally are values specified as Search Base during the LDAP search.

When the NIC OS 900 transmits the data received from the LDAP server 200 to the application 800 (step S119), the application 800 obtains the search result from the LDAP server 200 (step S120).

Next, as illustrated in FIG. 10, the application 800 performs a branch processing upon checking the search result given by the LDAP server 200 as to whether the user information 210 has been obtained, namely, whether the user exists (step S121). In a case where the user information 210 cannot be obtained, the application 800 performs the user notification processing upon selecting a message 3 “AP USER NOT REGISTERED” from among the messages illustrated in FIG. 18 (step S122).

In a case where the user information has been obtained, the application 800 performs a branch processing based on the usage limitation of the user information 210 as to whether the user has a usage permission (step S123). Various setting methods can be considered for the usage limitation. For example, it is assumed that the usage permission is expressed with a numeral of four digits, in which the first digit is the usage permission of the printer, the second digit is the usage permission of the copier, the third digit is the usage permission of the scanner, and the fourth digit is the usage permission of the facsimile machine. In addition, it is assumed that the value thereof “0” is “unable to use”, “1” is “only monochrome can be used”, and “2” is “both of color and monochrome can be used.” In addition, a method is considered of referring to the usage permission in the user information 210 and assuming “no permission” if the item of the printer is “0” and assuming “having permission” if the item is “1” or “2”. In a case where the user does not have the usage permission, the application 800 performs the user notification processing upon selecting a message 4 “AP USER ERROR” from among the messages illustrated in FIG. 18 (step S124).

In FIG. 11, in a case where the NIC 700 can communicate with the LDAP server 200, the NIC 700 obtains from the mass storage 500 the print data according to the user information 210. As illustrated in FIG. 11, in a case where the user has the usage permission, the application 800 uses the user name in the obtained user information 210 as the key to extract the job information 820 having the corresponding user name from the job list 805 (step S125). The application 800 makes the extracted job information 820 into a list to generate the execution list 804 (step S126).

The application 800 obtains a sub-user from the obtained user information 210 (step S127). If the sub-user 1 is obtained immediately before, the application 800 obtains the next sub-user 2. A series of processings from S127 to S130 relating to the sub-user is a processing performed to allow one user to output the printed material of multiple users. For example, conventionally, in a case where a secretary wants to output a printed material of his or her supervisor, he or she needs to borrow the IC card because one IC card allows registration of up to one user. In addition, one user who uses two PCs needs to carry two IC cards. The above-described problem can be solved by performing this series of processings relating to the sub-user, which enables outputting the printed material of multiple users with one IC card.

The application 800 checks the obtained sub-user (step S128), and in a case where all the sub-users up to the sub-user 4 are obtained or a case where any sub-user is not obtained or registered, the application 800 proceeds to S131. In a case where the sub-user is obtained, the application 800 extracts the job information 820 corresponding to the sub-user from the job list 805 (step S129), and adds the extracted job information 820 to the execution list 804 (step S130).

When all the sub-users are obtained, the application 800 sorts the generated execution list 804 (step S131). The job information 820 is sorted by the timestamp 824 and then sorted by the user name 821, so that the job information 820 is grouped by the user name 821 and sorted in time sequence. This sort can provide the output material grouped into each user when the printed material of multiple users is wanted to be output, thus saving trouble in separating the printed material. In addition, the printed material of each user is arranged in the order of timeout, namely, the order of the printed material is according to the instruction of the user who has executed printing and thus becomes an output order for the user to easily understand. On the other hand, the method of sort is not limited to this method, and the sort may be performed by the user name and subsequently by the timestamp.

Next, as illustrated in FIG. 12, the application 800 checks the number of pieces of the job information 820 in the execution list 804 (step S132). In a case of zero piece, the application 800 performs the user notification processing upon selecting a message 5 “AP NO JOB” from among the messages illustrated in FIG. 18 (step S133).

In a case where the number of pieces of the job information 820 in the execution list 804 is one or more pieces, the application 800 performs a loop processing for the number of pieces of the job information 820 in the execution list 804 (step S134). When all the job information 820 is referred to, the loop processing is terminated. This loop processing is a processing that performs step S135 to step S137 with respect to all the job information 820 existing in the execution list. In step S134, therefore, the application 800 determines whether the processing has finished with respect to all the job information 820 existing in the execution list. In a case where the application 800 determines that the processing has been finished, the application 800 proceeds to step S138. The application 800 determines whether the job can be introduced (step S135). Normally, print equipment has limitation on the RAM, and accordingly limits the print jobs allowed to be introduced at one time. The reason why a determination is made as to whether the job can be introduced is to prevent the printing from ending up in failure caused by the job introduced even though the introduction limitation has already been exceeded. Next, the application 800 performs a wait processing (step S136). In a case where the job exceeds the introduction limitation and cannot be introduced, this wait processing keeps on cycling in the loop (step S135 to step S137), and prevents a phenomenon that the CPU is occupied. The application 800 performs the detailed processing of output as illustrated in FIG. 13 (step S137), and clears all the job information 820 in the execution list 804 (step S138).

Next, the job output processing of the secure print system 1 will be described with reference to FIG. 13. In FIG. 13, the NIC 700 transmits the print data to the printing apparatus 1000.

As illustrated in FIG. 13, the application 800 obtains the job 310 from the file system 501 based on the job information 820 transmitted from upstream (step S201). The application 800 requests the mass storage 500 to obtain a file in the file system 501 that corresponds to the file name 822 stored in the job information 820. When the NIC OS 900 transmits the instruction from the application 800 to the mass storage 500 (step S202), the mass storage 500 reads a specified file from the file system 501 and returns the file to the application 800 (step S203), and the NIC OS 900 transmits the instruction from the mass storage 500 to the application 800 (step S204).

The application 800 requests the NIC OS 900 to decrypt the obtained job 310, and at the same time, specifies the decryption key and the decryption algorithm (step S205). The NIC OS 900 performs the decryption processing of the data (step S206), and the application 800 gives the print instruction of the decrypted job 310 (step S207). The NIC OS 900 receives the instruction from the application 800, and sends the printing apparatus 1000 the print instruction of the job 310 using the print information administration protocol communication (step S208).

The printing apparatus 1000 receives and stores the job 310 to the receive buffer to perform the storing processing (step S209). When the job 310 has been finished being stored to the receive buffer, the printing apparatus 1000 returns the control back to the NIC OS 900 without waiting for the printing to finish. The printing apparatus 1000 analyzes the print information administration header 311 of the data of the stored job 310 (step S210). The analyzed data is used for internal log data, not shown. The printing apparatus 1000 analyzes the PDL data in the job 310, generates the intermediate data of the drawing object, and further generates the bitmap image based on the intermediate data (step S211). The printing apparatus 1000 prints the generated bitmap image to a medium such as a sheet through a known print technology (step S212).

When the NIC OS 900 transmits the instruction of the printing apparatus 1000 to the application 800 (step S213), the application 800 requests the mass storage 500 to delete the corresponding job 310 from the file system 501 (step S214). When the NIC OS 900 transmits the instruction of the application 800 to the mass storage 500 (step S215), the mass storage 500 deletes the specified job 310 from the file system 501 (step S216). The NIC OS 900 transmits the instruction from the mass storage 500 to the application 800 (step S217).

Next, the LDAP server monitoring processing of the secure print system 1 will be described with reference to FIG. 14. In FIG. 14, the NIC 700 periodically confirms whether the communication with the LDAP server 200 is available. In addition, in a case where the communication with the LDAP server 200 is available and where the setting of storing the print data to the mass storage 500 is turned off, the NIC 700 turns on the setting again.

As illustrated in FIG. 14, when the application 800 registers the LDAP server monitoring processing as a thread to the NIC OS 900 and begins the processing (step S301), the NIC OS 900 checks whether the application 800 has been terminated (step S302).

In a case where the application 800 has not yet been terminated, the application 800 requests the NIC OS 900 to connect to the port of the primary, i.e., the LDAP server 200a, and the secondary, i.e., the LDAP server 200b, configured in the setting information 802 (step S303), and the NIC OS 900 connects to the two specified LDAP servers 200 (step S304). The application 800 confirms whether a connection to either of the primary, i.e., the LDAP server 200a, or the secondary, i.e., the LDAP server 200b, has been established (step S305), and in a case where the connection has been established, the application 800 confirms whether the print port is configured in the setting of the monitored port 907 (step S306). In a case where the print port is not configured in the monitored port 907, the application 800 adds the print port to the monitored port 907 (step S307). The application 800 performs a wait processing to avoid the possibility to occupy the CPU due to the loop (step S308).

Next, the user notification processing of the secure print system 1 will be described with reference to FIG. 15.

As illustrated in FIG. 15, the application 800 obtains a message text string transmitted from upstream (step S501), and requests the NIC OS 900 to produce the beep sound and display a specified message (step S502). The NIC OS 900 determines the type of the printing apparatus 1000, and instructs to produce the beep sound using an appropriate method (step S503). Because, for example, the UDP, the print information administration protocol, and the JL are used depending on the type of the apparatus, the NIC OS 900 absorbs this information and instructs to produce the beep sound according to a method appropriate for the type of the printing apparatus 1000. Regarding the panel display, a display instruction is sent to the printing apparatus 1000 using the MIB. The printing apparatus 1000 receives the instruction, produce the beep sound (step S504), and displays a specified message on the panel (step S505).

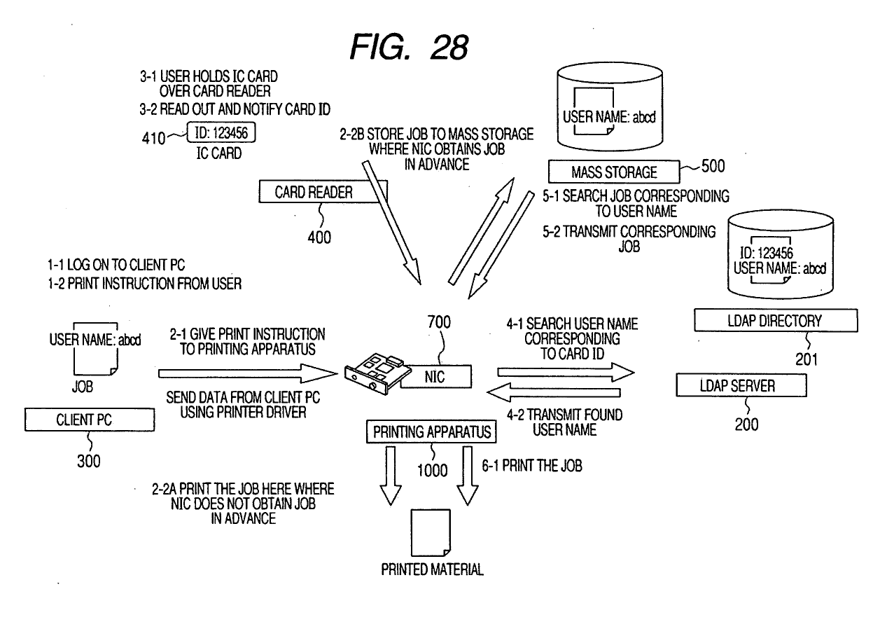

Next, an example of operation of the secure print system 1 according to the present embodiment will be described with reference to FIG. 28. FIG. 28 is a figure illustrating an example of operation of the secure print system 1.

A user logs on to the client PC 300 (step 1-1), and gives the print instruction of data (step 1-2). The printer driver generates a job from the data and transmits the job to the printing apparatus 1000 (step 2-1). Herein, if the NIC 700 is not monitoring the port on the printing apparatus 1000, the job is printed and output as it is from the printing apparatus 1000 (step 2-2A). On the other hand, in a case where the NIC 700 is monitoring the port, the NIC 700 obtains the job in advance before the job is handed over to the printing apparatus 1000, and stores the job in the mass storage 500 (step 2-2B).

The user who gives the print instruction holds up the IC card 410 over the card reader 400 (step 3-1). The card reader 400 reads the card ID 211 from the IC card 410, and notifies the card ID 211 to the printing apparatus 1000 (step 3-2). The printing apparatus 1000 inquires of the LDAP server 200 the user name corresponding to the received card ID 211 (step 4-1). The LDAP server 200 searches the LDAP directory 201, and transmits the found user name to the printing apparatus 1000 (step 4-2). The printing apparatus 1000 obtains the job corresponding to the user name from the mass storage 500 (step 5-1), and transmits the corresponding job to the printing apparatus 1000 (step 5-2). The printing apparatus 1000 outputs the received job by printing the job (step 6-1).

As described above, according to the embodiment of the present embodiment, a mechanism to avoid lagging printing work can be provided even in a case where the authentication cannot be performed because, for example, the authentication server is down.

The secure print system 1 according to the present embodiment is a high-availability system that does not stop the work of the user because the secure print system 1 can perform printing even in a case where the authentication server does not operate due to some reason. In addition, the secure print system 1 according to the present embodiment does not use the printer server, and thus is a more securely protected system that solves the problem that the print data is accumulated in the printer server to become a security hole. In addition, because the printer server is not used, the secure print system 1 can reduce the cost in establishing the environment for secure printing, and thus is a more inexpensive system.

Furthermore, the secure print system 1 according to the present embodiment does not use the printer server, and thus is a system more highly convenient for the user because the secure print system 1 allows the client to introduce the print job through the completely same operation without being aware of the difference regardless of whether the user performs the stored printing performing secure printing or does not perform the stored printing when the authentication server is down. In addition, the secure print system 1 according to the present embodiment does not use the printer server and does not need the setting of the printer driver to be changed, and thus is a system that is easy to be introduced and installed and that saves trouble.

### Second Embodiment

In the first embodiment, there exists a problem that in a case of a printer that cannot display a list of the print data on the operation unit, the print data cannot be deleted once the job is introduced because the print data cannot be selected by the user. Especially, there exists a problem that nothing can be done about a job introduced by mistake but to just print the job even though the job is essentially wanted to be deleted. The present embodiment solves at least a portion of these points.

The USB I/F controller 4004 allows the NIC 700 to connect to and communicate with USB equipment such as the card reader 400, the mass storage 500, and the USB hub 600, and executes communication control processings of the USB. The internal memory 4005 stores an OS for controlling the NIC 700, and stores application programs operating on the OS and setting information thereof. The memory controller 4006 controls access to the internal memory 4005 storing various applications and various data. The ROM 4007 is a read-only semiconductor memory, and stores a boot program because the content is not erased even when the power is turned off. The equipment I/F controller 4008 connects and allows communication between the NIC 700 and the printing apparatus 1000.

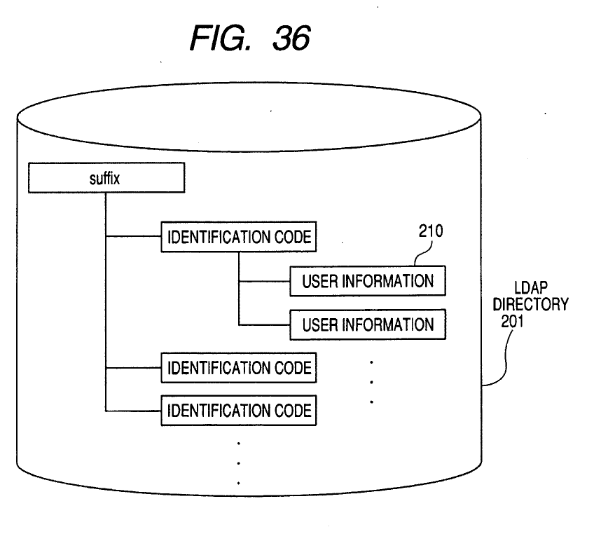

FIG. 6 is a block diagram illustrating the configuration of the secure print system 1 according to the present embodiment. FIG. 16 is the figure illustrating the example of setting information 802. FIG. 17 is the figure illustrating the details of the monitored port 907. FIG. 19 is a figure illustrating the details of the job 310. FIG. 20 is a figure illustrating the details of the print information administration header 311. FIG. 21 is the figure illustrating the details of the job information 820. FIG. 22 is the figure illustrating the details of the job list 805. FIG. 23 is the figure illustrating the details of the execution list 804. FIG. 24 is the figure illustrating the details of the file system 501. FIG. 34 is the figure illustrating the details of the IC card 410. FIG. 35 is the figure illustrating the example of the user information 210. FIG. 36 is a figure illustrating the details of the LDAP directory 201. FIG. 37 is a figure illustrating an example of a deletion setting 840. FIG. 38 is a figure illustrating an example of execution card information 850. FIG. 39 is a figure illustrating an example of recovery time information 860.

In the secure print system 1, the LDAP server 200, the client PC 300, and the NIC 700 connected to the printing apparatus 1000 are connected via the bidirectionally-communicable LAN 150. The mass storage 500, the USB hub 600, and the card reader 400 are connected to the NIC 700 via the USB cable 160 capable of USB communication. The LDAP server 200 has the LDAP directory 201, the LDAP function unit 202, and the I/F driver unit 190. The LDAP server 200 may be made in a redundant configuration, and multiple sets of LDAP servers 200 may be installed. The LDAP server 200 plays a role to search user information in the system, and is thus not limited to the LDAP server as long as it is a server that has storing and search function of the user information.

The LDAP directory 201 stores data as illustrated in FIG. 36. The LDAP directory 201 has one or multiple identification codes arranged under Suffix, i.e., the highest unit gathering a group of data, and has one or multiple pieces of user information 210 stored under these identification codes. Generally, the identification code is made up with the OU (Organization Unit). In Active Directory (registered trademark), Suffix corresponds to a unit called domain. As illustrated in FIG. 35, the user information 210 has the card ID 211, the user-name 212, the password 213, the sub-user 1 (214), the sub-user 2 (215), the sub-user 3 (216), the sub-user 4 (217), and the usage limitation 218.

As illustrated in FIG. 34, the card ID 211 registers an ID of the IC card 410 of the user, and is a value unique within Suffix. The user name 212 is the name of the user who possesses the IC card 410 corresponding to the card ID 211. The password 213 is stored to identify the user when the user authentication is performed. The sub-users 1 (214) to 4 (217) are aliases of the user name 212 mainly used by the user, and are user names used in a case where the user acts on behalf of another user. The usage limitation 218 stores limitation information on the usage of the printing apparatus 1000.

The description will be made using FIG. 6. As is similar to the previous embodiment, the LDAP function unit 202 performs connection of communication, authentication, search, modification, addition, deletion, disconnection according to the LDAP protocol. In the connection, the LDAP function unit 202 secures a logical communication path for a client that has issued a connection request. In the authentication, the LDAP function unit 202 searches the LDAP directory 201 for the user name that has issued the connection request, performs password verification, and replies the authentication result. In the search, the LDAP function unit 202 searches the LDAP directory 201 for the corresponding user based on the value specified by a search request, and replies the corresponding user information 210.

The I/F driver unit 190 connects to and communicates with external equipment via a network such as the LAN 150, and controls communication according to the communication protocol such as TCP/IP and UDP. The client PC 300 has the application unit 301, the printer driver unit 302, the transmission buffer 303 and the I/F driver unit 190. The application unit 301 provides graphical user interface to the user, and generates image data appropriate for the purpose of the user. The printer driver unit 302 converts the image data generated by the application unit 301 into page description language (PDL) data printable by the printing apparatus 1000. Furthermore, the printer driver unit 302 attaches to the PDL data the print information administration header 311 including job information such as the job owner 312 and the job name 313 as illustrated in FIG. 20, and generates the job 310 as illustrated in FIG. 19. The transmission buffer 303 realizes storing by temporarily storing the job 310 generated by the printer driver unit 302.

The USB hub 600 has the USB communication unit 195. The USB hub 600 relays the USB data, and transfers the USB data of the equipment connected to the USB hub 600 to each of other equipment. The USB communication unit 195 performs data communication such as control transfer, interrupt transfer, bulk transfer and isochronous transfer according to the USB specification. Transferring data is a necessary condition, and thus the transfer speed and the USB version do not matter.

The mass storage 500 has the file system 501, the file system administration unit 502, and the USB communication unit 195. As illustrated in FIG. 24, the file system 501 stores the job 310 in the internal storage apparatus (not shown). Furthermore, the file system 501 writes, reads, and deletes the job 310.

The card reader 400 of FIG. 2 has the USB communication unit 195 and the card reading unit 401. The card reading unit 401 reads the card ID 211 from the IC card 410 (memory medium). When the IC card 410 is held over the card reader 400, the card reading unit 401 reads information such as the card ID 211 from the IC card 410 (memory medium), and transmits the information to other equipment connected via the USB communication unit 195. It should be noted that although the present embodiment is configured to use the authentication performed by holding up the IC card over the card reader, the present embodiment may be configured to use the authentication that uses information about fingerprints or hand and finger veins (biometrics information). In this case, the embodiment can be realized by replacing the card reader 400 of FIG. 2 (FIG. 6) with a reader for reading an object of reading such as finger and hand (reading unit).

The NIC 700 of FIG. 2 (FIG. 6) has the application 800 and the NIC OS 900. The application 800 is a program operating on the NIC OS 900. The NIC OS 900 controls the NIC 700, and at the same time, administers the application 800 on the NIC 700 and gives various instructions to the printing apparatus 1000.

The application 800 of the NIC 700 of FIG. 6 has the setting information administration unit 801, the setting information 802, the LPR communication unit 803, the execution list 804, the job list 805, the LDAP communication unit 806, the LDAP server monitoring unit 807, the print information administration protocol analysis unit 808, the list administration unit 809, the user notification unit 810, the card reader administration unit 811, the file administration unit 812, the print instruction unit 813, the beep instruction unit 814 and the panel display instruction unit 815. In addition, although not illustrated in FIG. 6, the application 800 has the deletion setting 840 (FIG. 37), the execution card information 850 (FIG. 38) and the recovery time information 860 (FIG. 39).

The setting information administration unit 801 administers the setting information 802, illustrated in FIG. 44, needed to execute the application 800, and writes and reads the setting information 802. When the client PC 300 accesses the application 800 using a browser to configure the setting information of the application 800 and the application 800 receives an instruction from the client PC 300, the setting information administration unit 801 stores the configured data as the setting information 802. The setting information 802 has the suffix 831, the identification code 832, the primary server 833, the primary port 834, the secondary server 835, the secondary port 836, the user 837 and the password 838.

The suffix 831 and the identification code 832 are conditions with which a search location is specified when the search request is issued to the LDAP server 200. The primary server 833, the primary port 834, the secondary server 835 and the secondary port 836 are information with which the connection to the LDAP server 200 is established. Because the LDAP server 200 may be made in a redundant configuration, multiple sets of LDAP servers 200 such as primary and secondary can be configured. The user 837 and the password 838 are information needed to issue the authentication request to the LDAP server 200.

The LPR communication unit 803 communicates upon analyzing the LPR print protocol. Namely, the LPR communication unit 803 communicates upon analyzing the protocol through which the job 310 is received from the client PC 300. Herein, the LPR is noted as an example, but the protocol is not especially limited to the LPR as long as it is a printing protocol.

The execution list 804 is as illustrated in FIG. 23, and is a subset of the job list 805 illustrated in FIG. 22. When executing printing, the print instruction is given based on the job information 310 stored in the execution list 804. The job list 805 is made up with the job information 820 illustrated in FIG. 45. The job information 820 is extracted information needed to administer the job 310, and has the user name 821, the file name 822, the job name 823 and the timestamp 824. The job list 805 stores all the information of the job 310 stored in the file system 501.

The LDAP communication unit 806 communicates with the LDAP server 200 according to the LDAP protocol, and connects to the LDAP server 200 specified by the primary server and the primary port in the setting information 802. The LDAP communication unit 806 performs authentication using the user 837 and the password 838 in the setting information 802. In addition, the LDAP communication unit 806 searches the user information 210 (FIG. 35) associated with the card ID 211, taking the suffix 831 and the identification code 832 in the setting information 802 as the search location. In a case where neither the primary nor the secondary can be accessed, the designation of the print port in the monitored port 907 is canceled.

The LDAP server monitoring unit 807 periodically monitors whether the LDAP server 200 and the NIC 700 are in a state capable of communicating with each other. Actual connection processings are performed through the LDAP communication unit 806. During the monitoring processing, in a case where it is determined that the LDAP server 200 and the NIC 700 can communicate with each other and where the print port is not configured in the monitored port 907, the print port is added to the monitored port 907. Thus, the recovery of the print switching when the server is down is realized.

The print information administration protocol analysis unit 808 of FIG. 6 analyzes the print information administration header 311 included in the job 310. The print information administration header 311 is binary data attached to the head of the PDL data, and includes various job information. The job owner 312 and the job name 313 included in the print information administration header 311 are obtained, and a value analyzed by the print information administration protocol analysis unit 808 is used when the job information 820 is generated.

The list administration unit 809 administers the execution list 804 and the job list 805. When the job 310 is written to the file system 501, the list administration unit 809 receives the job information 820 from the file administration unit 812, and adds the job information 820 to the job list 805 to manage the job list 805. In addition, the list administration unit 809 extracts from the job list 805 the job information 820 corresponding to the user name given by the LDAP communication unit 806 to generate the execution list 804. Upon receiving a notification from the file administration unit 812 when printing is completed, the list administration unit 809 deletes the corresponding job information 820 from the job list 805.

The user notification unit 810 notifies an error to the user who uses the printing apparatus 1000. The user notification unit 810 has such functions as: appealing to the acoustic sense of the user by giving a beep instruction to the NIC OS 900 to cause the printing apparatus 1000 to produce the beep sound; and appealing to the visual sense of the user by giving a panel display instruction to cause the panel of the printing apparatus 1000 to display an arbitrary text.

The card reader administration unit 811 controls the card reader 400 connected to the NIC 700 via the USB 160. When the IC card 410 (memory medium) is held over the card reader 400, the card reader administration unit 811 obtains the card ID 211.

The file administration unit 812 administers the job 310 in the application 800. The file administration unit 812 stores the job 310 to the file system 501 upon encrypting the job 310. In addition, the file administration unit 812 decrypts the job 310, sends the job 310 to the print instruction unit 813, and deletes the corresponding job 310 from the file system 501 at a time when the job has been finished being introduced to the print instruction unit 813.

The print instruction unit 813 gives the print instruction of the decrypted job 310, having been sent from the file administration unit 812, to the NIC OS 900 using the print information administration protocol.

The beep instruction unit 814 receives the beep instruction from the user notification unit 810, and notifies the NIC OS 900. Regarding the beep sound, the producing of the beep can be realized with various methods such as using the print information administration protocol, the JL and the UDP, but it depends on the printing apparatus 1000 which function is supported. The beep instruction unit 814 gives an appropriate beep instruction by absorbing the difference of the type of the printing apparatus 1000. The panel display instruction unit 815 uses an MIB (Management Information Base) to cause the panel (not shown) of the printing apparatus 1000 to display an arbitrary message. In a case where the printing apparatus 1000 is of a model that cannot display for a certain period of time, the panel display instruction unit 815 resets the display upon displaying for several seconds.

The deletion setting 840 is as illustrated in FIG. 37, and is a setting about a deletion processing function of the print data stored in the mass storage 500 when the LDAP server 200 goes down and thereafter recovers. In a case of “ON”, the NIC 700 executes the deletion processing. In a case of “AUTO”, the NIC 700 checks the execution list 804, and executes the deletion processing if there exists a job which is to be deleted. In a case of “OFF”, the NIC 700 does not execute the deletion processing. The execution card information 850 is as illustrated in FIG. 38, and is information of the card owned by the user executing the deletion processing. The recovery time information 860 is as illustrated in FIG. 39, and is information indicating a time when the LDAP server 200 recovered after going down. It should be noted that in a case where such configuration is employed that it is periodically confirmed whether the communication with the LDAP server 200 is available or not, it may also be possible that the recovery time information 860 is not the time when the LDAP server 200 actually recovers but is a time when the communication with the LDAP server 200 is attempted to be made and the communication is confirmed to be established. Namely, the recovery time information 860 may also be referred to as connection time information. It should be noted that the time includes clock time.

Next, referring back to FIG. 6, the details of the NIC OS 900 will be described. The NIC OS 900 has the I/F driver unit 190, the USB communication unit 195, the encryption/decryption unit 905, the print information administration protocol analysis and communication unit 904, the JL communication unit 903, the UDP communication unit 902, the MIB communication unit 901, the communication control unit 906 and the monitored port 907.

The encryption/decryption unit 905 performs encryption and decryption of data. The encryption/decryption unit 905 is not limited to a fixed type, but can perform block encryption, e.g., DES (Data Encryption Standard), Triple DES, and AES (Advanced Encryption Standard) and stream encryption, e.g., RC4. The print information administration protocol analysis and communication unit 904 performs data communication according to the print information administration protocol. The print information administration protocol is a communication protocol for controlling the printing apparatus 1000, and can give the print instruction and produce the beep sound. The JL communication unit 903 performs JL communication. The JL is a job control language, and can give an information acquisition instruction of the printing apparatus 1000, a reception instruction of the PDL data and the beep instruction to the printing apparatus 1000.

The UDP communication unit 902 performs UDP communication. With the use of this UDP communication, the DNS (Domain Name System) query and the beep instruction can be performed. The MIB communication unit 901 performs MIB communication. The MIB is a protocol for administering communication equipment, and performs displaying on the panel of the printing apparatus 1000. The communication control unit 906 notifies the application 800 of data received from the I/F driver unit 190, and transmits the data to the printing apparatus 1000. In a case where the data is sent to a port that is configured in the monitored port 907, the communication control unit 906 notifies the application 800. In a case where the data is received by a port that is not configured in the monitored port 907, the communication control unit 906 transmits the data to the printing apparatus 1000. As illustrated in FIG. 17, the monitored port 907 is information for determining which of the application 800 or the printing apparatus 1000 the communication control unit 906 transmits the data to. The monitored port 907 specifies the communication port number for notifying the application 800.

Next, the printing apparatus 1000 will be described. The printing apparatus 1000 has the I/F driver unit 190, the receive buffer 1001, the transmit buffer 1002, the MIB communication unit 901, the UDP communication unit 902, the JL communication unit 903, the print information administration protocol analysis and communication unit 904, the LPR communication unit 803, the panel display unit 1008, the beep producing unit 1009, the PDL translator unit 1011, the equipment DB unit 1010, the drawing buffer 1012, the drawing unit 1013 and the printer engine unit 1014.

The receive buffer 1001 serves as a buffer material against processing delay by temporarily securing all the data received by the I/F driver unit 190. The transmit buffer 1002 serves as a buffer material against processing delay by temporarily securing all the data prior to be transmitted to the I/F driver unit 190. The panel display unit 1008 displays a specified message on the panel of the printing apparatus 1000. The beep producing unit 1009 activates a sound producing device (not shown) in the printing apparatus 1000 to produce the sound. The equipment DB unit 1010 stores information of the printing apparatus 1000 configured by the JL, and provides the information to the PDL translator unit 1011. The environmental information referred to herein is, for example, the number of prints.

The PDL translator unit 1011 performs a translation processing of the PDL data to convert the PDL data into intermediate data, i.e., a drawing object appropriate for drawing. The drawing buffer 1012 temporarily stores the intermediate data of the drawing object generated by the PDL translator unit 1011 until the printing is actually performed. The drawing unit 1013 actually draws the drawing object temporarily stored in the drawing buffer 1012 to generate image data, i.e., a bitmap image. The printer engine unit 1014 receives the bitmap image generated by the drawing unit 1013, and prints the bitmap image on a medium such as a sheet through a known print technology.

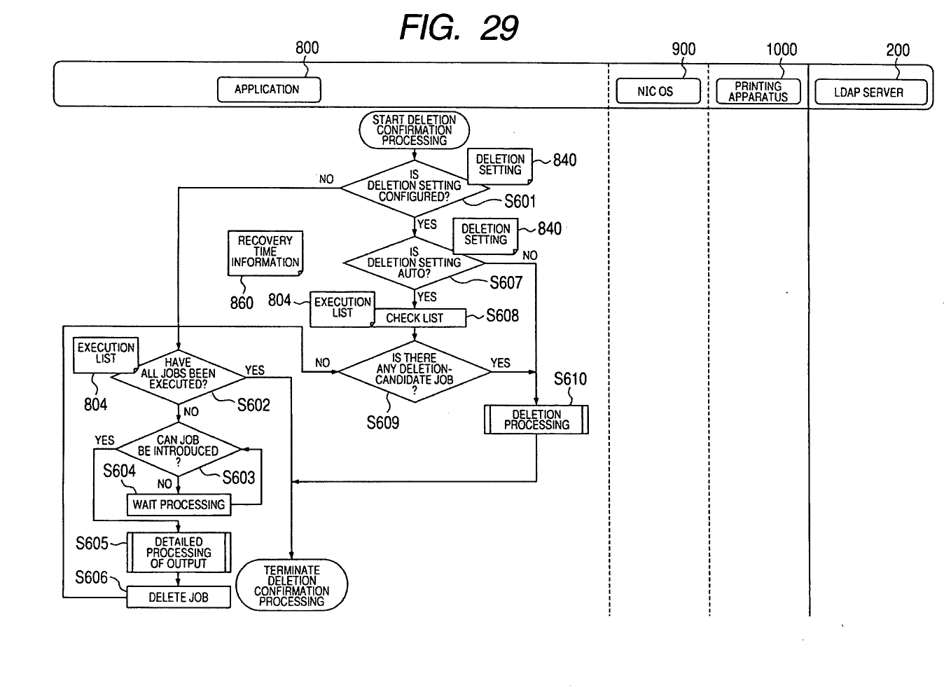

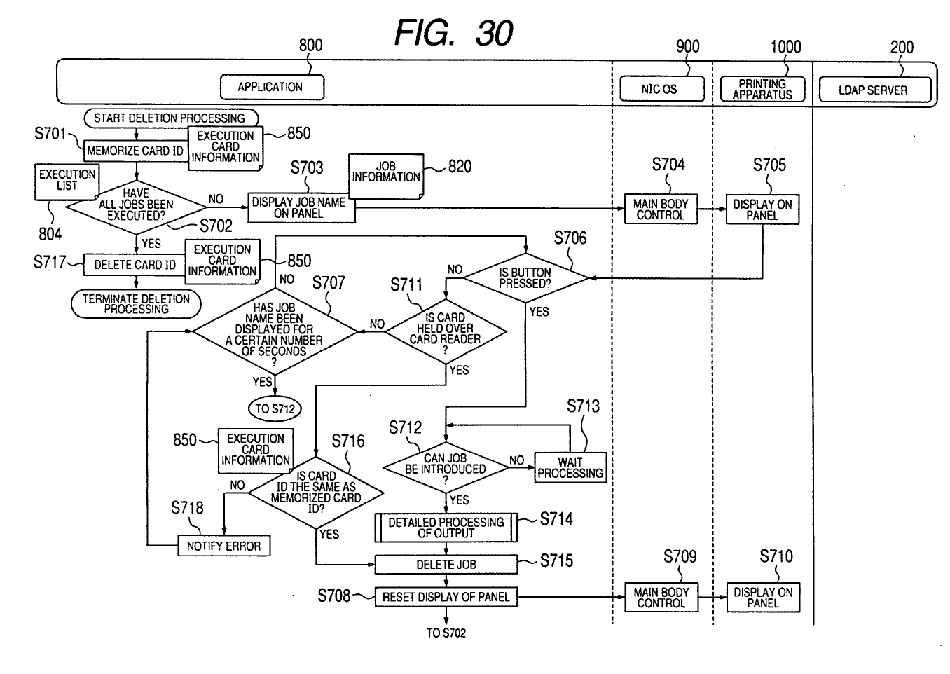

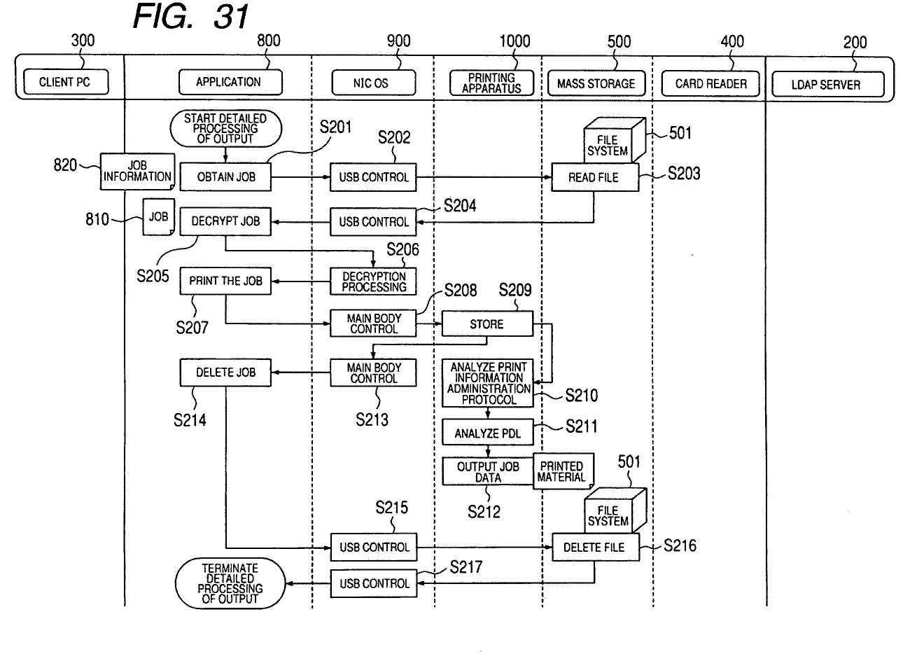

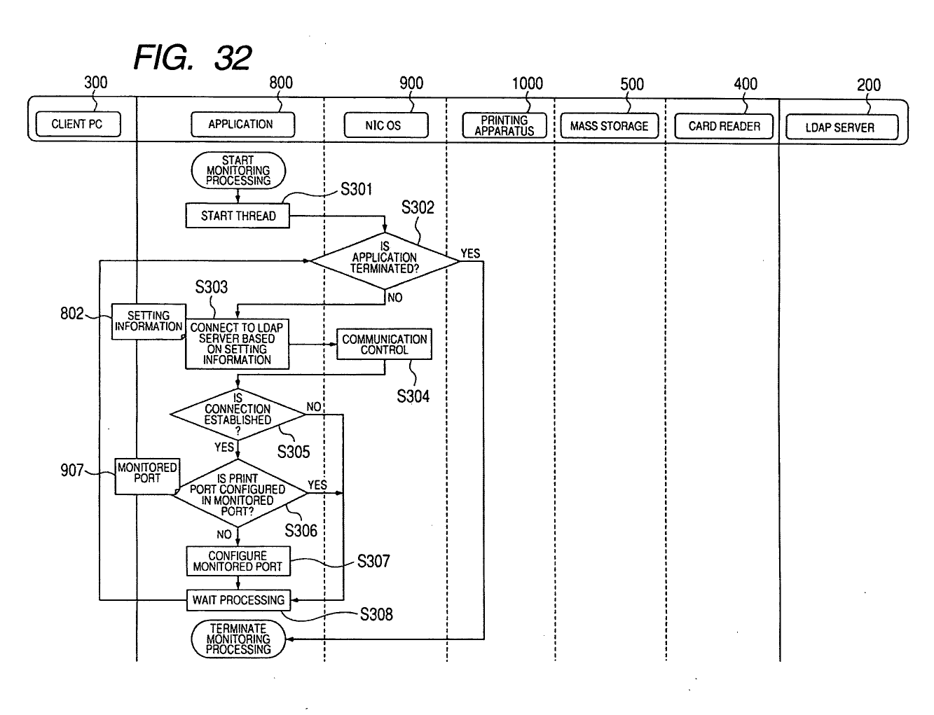

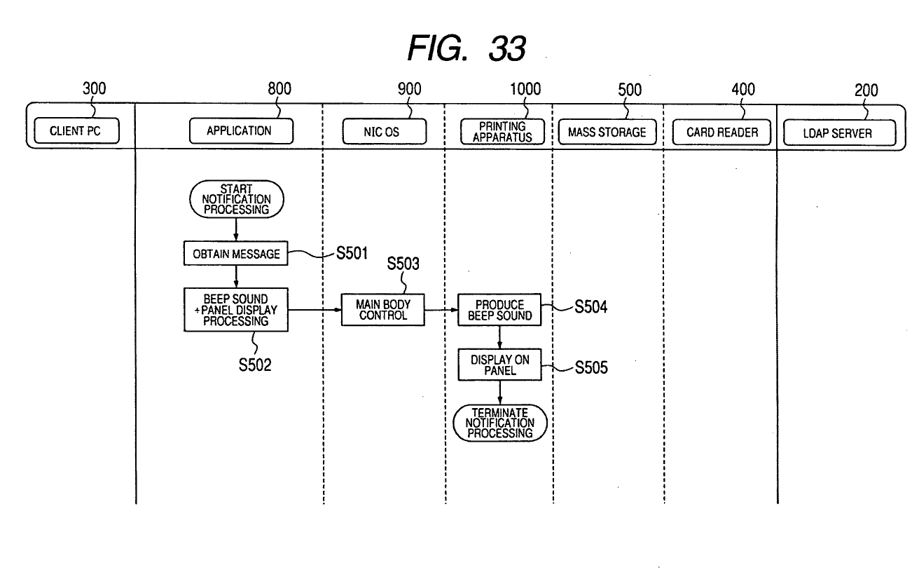

Next, the processings and configuration of FIG. 7 to FIG. 17 and FIG. 20 are the same as the previous embodiment. The different portion from the previous embodiment will be hereinafter described. Herein, FIG. 29 is a flowchart illustrating an example of a deletion confirmation processing procedure of the secure print system 1. FIG. 30 is a flowchart illustrating an example of a deletion processing procedure of the secure print system 1. FIG. 31 is a flowchart illustrating an example of a detailed procedure of an output processing of the secure print system 1. FIG. 32 is a flowchart illustrating an example of the LDAP server monitoring processing procedure of the secure print system 1. FIG. 18 is a figure illustrating an example of messages displayed on the printing apparatus 1000.

Hereinbelow, the processings performed by the NIC 700 will be described, distinguishing between the function of the application 800 and the function of the NIC OS 900. Accordingly, it is assumed for the sake of convenience that the subjects of the processings are the application 800 and the NIC OS 900. It should be noted that in reality the subject that performs the processings is the NIC 700. The NIC 700, which is hardware, executes later-described processings by working together with the application 800 or the NIC OS 900, which are software.

In FIG. 7, the NIC 700 receives the print data from the client PC 300. In addition, the NIC 700 stores the received print data to the mass storage 500p. In addition, the NIC 700 transmits the print data to the printing apparatus 1000.

As illustrated in FIG. 7, in the processing of introduction of job to the secure print system 1, the application of the client PC 300 generates the job 310 with the printer driver (step S001). When the client PC 300 transmits the generated job 310 to the NIC OS 900 (step S002), the NIC OS 900 receives the data transmitted from the client PC 300 and performs a branch processing upon checking the setting of the monitored port 907 (step S003). It is not necessary for the client PC 300 to be aware of whether the printing method uses the mass storage 500 or directly outputs the print data from the printing apparatus 1000 due to the inability to communicate with the LDAP server 200. The secure print system is realized that saves trouble in changing the settings and has higher usability because during printout the job 310 can be transmitted without being aware of whether the communication with the LDAP server 200 is available or not.

In a case where the data is addressed to a port other than the ports configured in the monitored port 907 to be monitored, the NIC OS 900 transmits the received job 310 to the printing apparatus 1000 (step S004), and the printing apparatus 1000 receives the transmitted job 310, and performs a storing processing by storing the job 310 to the receive buffer 1001 (step S005). The printing apparatus 1000 analyzes the print information administration header 311 of the data of the stored job 310 (step S006). The analyzed data is used for an internal log data, not shown. The printing apparatus 1000 analyzes the PDL data in the job 310, generates the intermediate data of the drawing object, and further generates the bitmap image based on the intermediate data (step S007). The printing apparatus 1000 prints the generated bitmap image to a medium such as a sheet through a known print technology (step S008).

In a case where the received data is a data addressed to a port configured in the monitored port 907, the NIC OS 900 transmits the job 310 to the application 800 where the received data is a data addressed to a port configured to be monitored (step S009). The application 800 analyzes the print information administration header 311 of the job 310 to obtain the job owner and the job name (step S010), and the application 800 generates the job information 820 (step S011). The obtained job owner 312 is stored as the user name 821, and the obtained job name 313 is stored as the job name 823. In addition, a text string unique within the application is generated and is made to be the file name 822. The timestamp 824 is stored after the file is written.

The application 800 transmits the data of the job 310 to the NIC OS 900 and specifies an encryption key and an encryption algorithm to encrypt the job 310 (step S012). The NIC OS 900 encrypts the transmitted job data using the specified parameter (step S013). The application 800 writes (writing) the job encrypted by the NIC OS 900 to the file system 501 (memory unit) (step S014). Writing the job 310 to the file system 501 eliminates the necessity to write the job 310 to the printer server 101 as conventionally. Thus, the printer server 101 becomes unnecessary, and the secure print system is realized that is more highly secure. In addition, the fact that the printer server 101 is unnecessary saves the cost of the server installation and saves the trouble in configuring the settings of the server installation during the introduction of the secure print system. Furthermore, in the unlikely event that the mass storage 500 is removed from the printing apparatus 1000, there is no risk for the PDL data in the job 310 to be read out because the job 310 is written encrypted. Thus, high security is realized.

When the NIC OS 900 notifies the mass storage 500 of the processing that the job 310 is saved (step S015), the mass storage 500 writes the encrypted job 310 to the file system 501 (step S016). The NIC OS 900 notifies the application 800 of the processing that the encrypted job 310 is written to the file system 501 (step S017). When the processing is notified to the application 800, the application 800 obtains the timestamp (memory time information) of the time when the job 310 has finished being written to the file system 501, and stores the timestamp to the timestamp 824 of the job information 820 (step S018). The application 800 stores the generated job information 820 to the job list 805 (step S019).

Next, the processing of job output of the secure print system 1 will be described with reference to FIGS. 8, 9, 10, 11, 12, 29, 30 and 31. In FIG. 8, the NIC 700 transmits the authentication request including the user information 210 to the LDAP server 200. In addition, the NIC 700 makes a determination whether the NIC 700 can communicate with the LDAP server 200. In addition, in a case where the NIC 700 cannot communicate with the LDAP server 200, the NIC 700 turns off a setting of storing the print data to the mass storage 500. In addition, in a case where the NIC 700 can communicate with the authentication server and where the setting of storing the print data to the mass storage 500 is turned off, the NIC 700 turns on that setting again. As illustrated in FIG. 8, the card reader 400 detects the IC card 410 (memory medium), and reads the card ID 211 recorded in the IC card 410 (step S100), and the NIC OS 900 transmits the read information to the application 800 (step S101). It is assumed that this reading obtains the card ID by reading a special area of the IC card (memory medium). In addition, this special area may also store the identification information of the card or the identification information of the user.

The application 800 obtains the card ID from the NIC OS 900 (user identification information reception). Then, the application 800 checks the setting of the monitored port 907 to confirm whether the print port (for example, port 9100 in a case of Raw, port 515 in a case of LPR) is configured or not (step S102). In a case where the print port is not included in the ports to be monitored and where the application 800 cannot communicate with the LDAP server 200, the application 800 performs a user notification processing as illustrated in FIG. 15 upon selecting the message 1 “AP STANDARD PRINT” from among the messages illustrated in FIG. 18 (step S103).

In a case where the print port is configured in the monitored port 907 or where the print port is not included in the ports to be monitored but the application 800 communicates with the LDAP server 200 to find to be able to establish communication therewith, the application 800 adds the print port to the monitored port. The application 800 attempts to communicate with the LDAP server 200 based on the setting information 802 (step S104). Specifically, the application 800 refers to the setting information 802 and communicates with the primary, i.e., the primary port of the LDAP server 200a, and if the application 800 cannot communicate therewith, the application 800 communicates with the secondary, i.e., the secondary port of the LDAP server 200b. In addition, in a case where the application 800 can communicate with the LDAP server 200 at this moment, the application 800 sets the recovery time information 860 to the current time (time information memory). Whether the execution list 804 has any deletion-candidate job can be automatically determined by comparing the timestamp of the job information 820 in the execution list 804 and the timestamp configured in the recovery time information 860.

The NIC OS 900 attempts to communicate with the LDAP server 200 based on the connection request (step S105), the application 800 performs a branch processing based on whether or not the connection attempt has succeeded (communication availability determination) (step S106). Specifically, in a case where neither the primary, i.e., the LDAP server 200a, nor the secondary, i.e., the LDAP server 200b, cannot be communicated with, the connection is deemed to have failed. Then, the application 800 cancels the setting of the print port configured in the monitored port 907 (step S107), and performs the user notification processing upon selecting the message 2 “AP SERVER ERROR” from among the messages illustrated in FIG. 18 (step S108). In a case where the LDAP server 200 cannot be communicated with, the job 310 is directly printed from the printing apparatus 1000 without being saved in the mass storage 500 in the next and subsequent prints because the setting of the monitored port 907 is canceled. Thus, the printed materials can be output even in a state where the communication with the LDAP server 200 is unavailable.

Next, in a case where either of the primary, i.e., the LDAP server 200a, or the secondary, i.e., the LDAP server 200b, can be communicated with as illustrated in FIG. 9, the application 800 performs the LDAP authentication (step S109). The authentication request is issued by transmitting the user 837 and the password 838 of the setting information 802 to the LDAP server 200 (authentication request transmission). It should be noted that this authentication processing described here is a processing in a case where a rigid security is enforced, namely, a search is not allowed without the authentication performed by the LDAP server 200. As another embodiment, the processings from S109 to S114 relating to the authentication may be omitted in a case where a setting of not requiring the authentication prior to performing the search (setting of non-authentication) is made.

The NIC OS 900 transmits to the LDAP server 200 the data transmitted from the application 800 (step S110). The LDAP server 200 searches the LDAP directory 201 with the user name of the data transmitted by the NIC 700. In a case where the user is found, The LDAP server 200 verifies the password 213 included in the user information 210 of the user corresponding to the transmitted data, and replies the authentication result (step Sill). When the NIC OS 900 transmits the data received from the LDAP server 200 to the application 800 (step S112), the application 800 receives the LDAP authentication result (step S113).

The application 800 performs a branch processing based on whether the authentication result in the foregoing S113 has succeeded or not (step S114), and if the authentication fails, the application 800 performs the user notification processing upon selecting the message 2 “AP SERVER ERROR” from among the messages illustrated in FIG. 18 (step S115). If the authentication succeeds, the application 800 performs the search of the card ID 211 based on the setting information 802 with the LDAP server 200 (step S116). The application 800 specifies the search location using the suffix 831 and the identification code 832 of the setting information 802. The NIC OS 900 transmits to the LDAP server 200 the data transmitted from the application 800 (step S117). The LDAP server 200 searches the LDAP directory 201 based on the data transmitted from the application 800, and replies the search result (step S118). The LDAP server 200 searches the specified card ID 211 from the data residing under the suffix 831 and the identification code 832 specified, and transmits the found user information 210. The suffix 831 and the identification code 832 are information that is specified to identify the location of the user within the LDAP directory 201, and generally are values specified as Search Base during the LDAP search.

When the NIC OS 900 transmits the data received from the LDAP server 200 to the application 800 (step S119), the application 800 obtains the search result from the LDAP server 200 (user identification information reception) (step S120).

Next, as illustrated in FIG. 10, the application 800 performs a branch processing upon checking the search result given by the LDAP server 200 as to whether the user information 210 has been obtained, namely, whether the user exists (step S121). In a case where the user information 210 cannot be obtained, the application 800 performs the user notification processing upon selecting the message 3 “AP USER NOT REGISTERED” from among the messages illustrated in FIG. 18 (step S122).

In a case where the user information has been obtained, the application 800 performs a branch processing based on the usage limitation of the user information 210 as to whether the user has a usage permission (step S123). Various setting methods can be considered for the usage limitation. For example, it is assumed that the usage permission is expressed with a numeral of four digits, in which the first digit is the usage permission of the printer, the second digit is the usage permission of the copier, the third digit is the usage permission of the scanner, and the fourth digit is the usage permission of the facsimile machine. In addition, it is assumed that the value thereof “0” is “unable to use”, “1” is “only monochrome can be used”, and “2” is “both of color and monochrome can be used.” In addition, a method is considered of referring to the usage permission in the user information 210 and assuming “no permission” if the item of the printer is “0” and assuming “having permission” if the item is “1” or “2”. In a case where the user does not have the usage permission, the application 800 performs the user notification processing upon selecting the message 4 “AP USER ERROR” from among the messages illustrated in FIG. 18 (step S124).

In FIG. 11, in a case where the NIC 700 can communicate with the LDAP server 200, the NIC 700 obtains from the mass storage 500 the print data according to the user information 210. As illustrated in FIG. 11, in a case where the user has the usage permission, the application 800 uses the user name in the obtained user information 210 as the key to extract the job information 820 having the corresponding user name from the job list 805 (step S125). The application 800 makes the extracted job information 820 into a list to generate the execution list 804 (step S126).

The application 800 obtains a sub-user from the obtained user information 210 (step S127). If the sub-user 1 is obtained immediately before, the application 800 obtains the next sub-user 2. A series of processings from S127 to S130 relating to the sub-user is a processing performed to allow one user to output the printed material of multiple users. For example, conventionally, in a case where a secretary wants to output a printed material of his or her supervisor, he or she needs to borrow the IC card because one IC card allows registration of up to one user. In addition, one user who uses two PCs needs to carry two IC cards. The above-described problem can be solved by performing this series of processings relating to the sub-user, which enables outputting the printed material of multiple users with one IC card.

The application 800 checks the obtained sub-user (step S128), and in a case where all the sub-users up to the sub-user 4 are obtained or a case where any sub-user is not obtained or registered, the application 800 proceeds to S131. In a case where the sub-user is obtained, the application 800 extracts the job information 820 corresponding to the sub-user from the job list 805 (step S129), and adds the extracted job information 820 to the execution list 804 (step S130).

When all the sub-users are obtained, the application 800 sorts the generated execution list 804 (step S131). The job information 820 is sorted by the timestamp 824 and then sorted by the user name 821, so that the job information 820 is grouped by the user name 821 and sorted in time sequence. This sort can provide the output material grouped into each user when the printed material of multiple users is wanted to be output, thus saving trouble in separation. In addition, the printed material of each user is arranged in the order of timeout, namely, the order of the printed material is according to the instruction of the user who executed printing and thus becomes an output order for the user to easily understand. On the other hand, the method of sort is not limited to this method, and the sort may be performed by the user name and subsequently by the timestamp.

Next, as illustrated in FIG. 12, the application 800 checks the number of pieces of the job information 820 in the execution list 804 (step S132). In a case of zero piece, the application 800 performs the user notification processing upon selecting the message 5 “AP NO JOB” from among the messages illustrated in FIG. 18 (step S133). Next, the application 800 performs the deletion confirmation processing as illustrated in FIG. 29 (step S134), and clears all the job information 820 in the execution list 804 (step S138). Next, the deletion confirmation processing of the secure print system 1 will be described with reference to FIG. 29.

First, the application 800 refers to the deletion setting 840 (step S601). Herein, if the deletion setting 840 is “OFF”, the application 800 proceeds to step S602. If the deletion setting 840 is “ON” or “AUTO”, the application 800 proceeds to step S607. The reason why the deletion setting 840 is confirmed here is that the normal printing processing is performed if the deletion setting 840 is not turned on because the deletion processing illustrated in FIG. 30 consumes more time than the normal printing.

In a case where the determination in step S601 determines that the deleting setting 840 is “OFF”, the application 800 performs a loop processing for the number of pieces of the job information 820 in the execution list 804 (step S602). When all the job information 820 are referred to, the loop processing is terminated. This loop processing is a processing to perform step S603 to step S606 with respect to all the job information 820 existing in the execution list. In step S602, a determination is made as to whether the processing has finished with respect to all the job information 820 existing in the execution list, and in a case where the processing has finished, the deletion confirmation processing is terminated. The application 800 makes a determination whether the job can be introduced (step S603). Normally, print equipment has limitation on the RAM, and accordingly limits the print jobs allowed to be introduced at one time. The reason why a determination is made as to whether the job can be introduced is to prevent the printing from ending up in failure caused by the job introduced even though the introduction limitation has already been exceeded. Next, the application 800 performs a wait processing (step S604). In a case where the job exceeds the introduction limitation and cannot be introduced, this wait processing keeps on cycling in the loop (step S603 to step S604), and prevents a phenomenon that the CPU is occupied. The application 800 performs the detailed processing of output as illustrated in FIG. 31 (step S605), and deletes the job information 820 from the execution list 804 (step S606).

In a case where the determination in step S601 determines that the deleting setting 840 is “ON” or “AUTO”, the application 800 makes a determination whether the deletion setting 840 is “AUTO” (step S607). The reason why the deletion setting 840 is confirmed here is to allow switching according to the setting so that the deletion processing need not always be performed because the deletion processing illustrated in FIG. 30 consumes more time than the normal printing.

In a case where the deletion setting 840 is determined to be “ON” in step S607, the application 800 performs the deletion processing illustrated in FIG. 30 (step S610). Herein, if the deletion setting 840 is “AUTO”, the execution list 804 is confirmed (step S608). Specifically, the timestamp 824 in the job information 820 existing in the execution list 804 (time (including clock time) when the print data is stored) is compared with the recovery time information 860. This comparison is performed with respect to all the job information 820 in the execution list 804. As a result, if there exists at least one piece of job information 820 prior to the recovery time information 860, a deletion-candidate job is deemed to exist, and on the contrary, if there exists none, a deletion-candidate job is deemed not to exist (step S609). Thus, a useless job can be avoided from being output when the LDAP server 200 recovers.

The deletion-candidate job is a job that has been introduced before the authentication server goes down and that could not be printed thereafter because the authentication server is down. Even if the job is to be deleted, a user's judgment is required to determine whether the job should be actually deleted. This is because the job may be deleted only in a case where the user has printed a job of the same content after the authentication server is down but the job should not be deleted other than such case, and no one but the user himself knows whether the job of the same content has been printed. For example, even if all of the user name 821, the file name 822 and the job name 823 illustrated in FIG. 21 are the same, the system is unable to determine whether the content is the same. To this end, in the embodiment of the present embodiment, a determination is made, not based on the content of the introduced job (the file name 822 and the job name 823) but is made based on the time when the job is introduced (the timestamp 824), and the jobs that need to be judged by the user are notified to the user as the deletion-candidate jobs.

In a case where there does not exist any deletion-candidate job in step S609, the application 800 proceeds to step S602 to perform normal printing. On the other hand, in a case where there exists the deletion-candidate job in step S609, the application 800 performs the deletion processing as illustrated in FIG. 30 (step S610).

Next, the deletion processing of the secure print system 1 will be described with reference to FIG. 30. It should be noted that the deletion processing has there patterns. The first is a method of having the user perform the deletion confirmation of all the jobs in the execution list 804, which is described hereinbelow. The second is to have the user perform the deletion confirmation of only the jobs determined in step S609 to be deletion-candidate among the jobs existing in the execution list 804. The remaining jobs are automatically printed through the flow from step S602 to step S606 of FIG. 29. The third is to automatically delete the jobs determined in step S609 to be deletion-candidate among the jobs existing in the execution list 804 without having the deletion confirmation performed by the user. The remaining jobs are automatically printed through the flow from step S602 to step S606. The flow of the first patter will be hereinafter described.

Hereinafter, the description will be made using FIG. 30. First, the application 800 stores the card ID 211 read in step S100 to the execution card information 850 (user identification information memory) (step S701). Thus, during deletion, this prevents unrighteous deletion performed by another user who holds up the card over the card reader. Subsequently, the application 800 performs a loop processing for the number of pieces of the job information 820 in the execution list 804 (step S702). When all the job information 820 is referred to, the loop processing is terminated. This loop processing is a processing that performs step S703 to step S715 with respect to all the job information 820 existing in the execution list. In step S702, it is determined whether the processing has finished with respect to all the job information 820 existing in the execution list. In a case where it is determined that the processing has been finished, the card ID 211 configured in the execution card information 850 is deleted (step S717), and the deletion processing is terminated.

The application 800 obtains the job information 820 from the execution list 804 (print data identification information acquisition), and gives the NIC OS 900 an instruction to display the job name 823 therein (print data identification information) on the panel (print data identification information transmission) (step S703). The NIC OS 900 transfers the instruction received from the application 800 to the printing apparatus 1000 (print data identification information transmission) (step S704). The printing apparatus 1000 displays the job name 823 on the panel (identification information notification) based on the instruction received from the NIC OS 900 (step S705).

The application 800 makes a determination whether a button on the panel arranged on the printing apparatus 1000 (print instruction button) has been pressed down (step S706). The determination whether the button on the panel is pressed down is made by determining that the button is pressed down upon receiving a notification that the button has been pressed down from the NIC OS 900 that has detected that the button has been pressed down. If the button is pressed down, the processing proceeds to S712. It should be noted that such configuration may also be employed that the processings of S708 to S710 are executed as the interruption processing at this timing to immediately reset the display unit of the panel. On the other hand, if the button is not pressed down, the application 800 makes a determination whether the card is held over the card reader while the job name 823 is displayed on the display unit of the panel (between step S703 and step S705) (S711). If the card is held over the card reader, the card ID 211 of the card held over the card reader is compared with the execution card information 850 (a determination is made as to whether they are the same) (step S716). The reason why the card ID 211 is compared here is to prevent a person other than the user who has held the card over the card reader at first from unrighteously deleting the printed material of another person. In a case where the card ID 211 is the same as (corresponds to) the execution card information 850, a later-described job deletion is performed (step S715). In a case where the card ID 211 is different from the execution card information 850, it is determined that the user is different from the original user, and an error is notified to the effect that deletion cannot be performed (S718). This error notification may employ a configuration of making the notification by displaying a message “deletion cannot be performed” on the display unit of the panel or a configuration of notifying with sound or voice. In a case where the card is not held over the card reader, it is confirmed whether the job name 823 is displayed on the display unit of the panel for a certain number of seconds (notification for predetermined time) (step S707), and if the job name 823 is not displayed for a certain number of seconds, the pressing-down confirmation of the button of the panel (step S706) is performed again. The reason why the confirmation is made as to whether the button of the panel is pressed down is to improve the convenience. If this is not performed, a wait always occurs for several seconds even for the job that the user surely knows is unnecessary. Thus, the printing is immediately performed upon hiding the job that is clearly unnecessary by pressing the button of the panel. In addition, the reason why the job name 823 is displayed on the display unit of the panel for a certain number of seconds is to allow the user to recognize the displayed job name and to give time to hold the card over the card reader.

In a case where it is determined in step S706 that the button of the panel is pressed down again, the application 800 determines that the corresponding job is not to be deleted, and makes a determination whether the job can be introduced (step S712). Normally, print equipment has limitation on the RAM, and accordingly limits the print jobs allowed to be introduced at one time. The reason why a determination is made as to whether the job can be introduced is to prevent the printing from ending up in failure caused by the job introduced even though the introduction limitation has already been exceeded. Next, in a case where the introduction limitation of the job (the number of jobs that can be introduced) is exceeded (NO in step S712), the application 800 performs a wait processing, namely, a temporary wait processing (step S713). In a case where the job exceeds the introduction limitation and cannot be introduced, this wait processing prevents performing step S712 without waiting, thus preventing a phenomenon that the CPU is occupied. In a case where it is determined in step S712 that the job can be introduced, the application 800 performs the detailed processing of output as illustrated in FIG. 31 (step S714), and deletes the job information 820 from the execution list 804 (step S715). In addition, the file system 501 deletes the corresponding job. The application 800 asks the NIC OS 900 to reset the display unit of the panel (step S708), after the job is deleted in step S715 or after the job name 823 is displayed on the panel for a certain number of seconds (in a case where it is determined in S707 that the job name 823 has been displayed for a certain number of seconds).

The NIC OS 900 transfers the instruction received from the application 800 to the printing apparatus 1000 (step S709). The printing apparatus 1000 resets the panel display based on the instruction received from the NIC OS 900 (step S710). Although the resetting of the display unit of the panel is configured to be executed after the processing of S715 is executed, but the configuration is not limited thereto, and the panel reset processing may be performed at an arbitrary timing. For example, in a case where it is determined in S707 that the job name 823 is displayed for a certain number of seconds, the processing of S707 is executed before proceeding to the processing of S712. Alternatively, in a case where it is determined in S706 that the button is pressed down, the processing of S707 is executed before proceeding to the processing of S712.

After the processing of step S708 has been finished, the application 800 returns back to step S702, and proceeds to the processing of the subsequent job information 820 in the execution list 804.

Next, the detailed processing of job output of the secure print system 1 will be described with reference to FIG. 31. In FIG. 31, the NIC 700 transmits the print data to the printing apparatus 1000.

As illustrated in FIG. 31, the application 800 obtains the job 310 from the file system 501 based on the job information 820 transmitted from upstream (step S201). The application 800 requests the mass storage 500 to obtain a file within the file system 501 that corresponds with the file name 822 contained in the job information 820. When the NIC OS 900 transmits the instruction from the application 800 to the mass storage 500 (step S202), the mass storage 500 reads a specified file from the file system 501 and returns the file to the application 800 (step S203), and the NIC OS 900 transmits the instruction from the mass storage 500 to the application 800 (step S204).

The application 800 requests the NIC OS 900 to decrypt the obtained job 310, and at the same time, specifies the decryption key and the decryption algorithm (step S205). The NIC OS 900 performs the decryption processing of the data (step S206), and the application 800 gives the print instruction of the decrypted job 310 (step S207). The NIC OS 900 receives the instruction from the application 800, and sends the printing apparatus 1000 the print instruction of the job 310 using the print information administration protocol communication (step S208).

The printing apparatus 1000 receives and stores the job 310 to the receive buffer to perform the storing processing (step S209). When the job 310 has been finished being stored to the receive buffer, the printing apparatus 1000 returns the control back to the NIC OS 900 without waiting for the printing to finish. The printing apparatus 1000 analyzes the print information administration header 311 of the data of the stored job 310 (step S210). The analyzed data is used for internal log data, not shown. The printing apparatus 1000 analyzes the PDL data in the job 310, generates the intermediate data of the drawing object, and further generates the bitmap image based on the intermediate data (step S211). The printing apparatus 1000 prints the generated bitmap image to a medium such as a sheet through a known print technology (step S212). When the NIC OS 900 transmits the instruction of the printing apparatus 1000 to the application 800 (step S213), the application 800 requests the mass storage 500 to delete the corresponding job 310 from the file system 501 (step S214). When the NIC OS 900 transmits the instruction of the application 800 to the mass storage 500 (step S215), the mass storage 500 deletes the specified job 310 from the file system 501 (step S216). The NIC OS 900 transmits the instruction from the mass storage 500 to the application 800 (step S217).

Next, the LDAP server monitoring processing of the secure print system 1 will be described with reference to FIG. 32. In FIG. 32, the NIC 700 periodically confirms whether the communication with the LDAP server 200 is available. In addition, in a case where the communication with the LDAP server 200 is available and where the setting of storing the print data to the mass storage 500 is turned off, the NIC 700 turns on the setting again.

As illustrated in FIG. 32, when the application 800 registers the LDAP server monitoring processing as a thread to the NIC OS 900 and begins the processing (step S301), the NIC OS 900 checks whether the application 800 has been terminated (step S302). In a case where the application 800 has not yet been terminated, the application 800 requests the NIC OS 900 to connect to the port of the primary, i.e., the LDAP server 200a, and the secondary, i.e., the LDAP server 200b, configured in the setting information 802 (step S303), and the NIC OS 900 connects to the two specified LDAP servers 200 (step S304).

The application 800 confirms whether a connection to either of the primary, i.e., the LDAP server 200a, or the secondary, i.e., the LDAP server 200b, has been established (communication availability determination) (step S305), and in a case where the connection has been established, the application 800 confirms whether the print port is configured in the setting of the monitored port 907 (step S306). In a case where the print port is not configured in the monitored port 907, the application 800 adds the print port to the monitored port 907 (step S307). In a case where the communication with the LDAP server 200 is available at this moment, the current clock time is set to the recovery time information 860. Whether the execution list 804 has any deletion-candidate job can be automatically determined by comparing the timestamp of the job information 820 in the execution list 804 and the timestamp configured in the recovery time information 860. The application 800 performs a wait processing to avoid the possibility to occupy the CPU due to the loop (step S308).

Next, an embodiment of the secure print system 1a according to the present embodiment will be described with reference to FIG. 40. FIG. 40 is a figure illustrating the embodiment of the secure print system 1a.

The user logs on to the client PC 300 (step 1-1), and gives the print instruction of data (step 1-2). The printer driver generates the job from the data and transmits the job to the printing apparatus 1000 (step 2-1). Herein, if the NIC 700 is not monitoring the port on the printing apparatus 1000, the job is output as it is from the printing apparatus 1000 (step 2-2A). On the other hand, in a case where the NIC 700 is monitoring the port, the NIC 700 obtains the job in advance before the job is handed over to the printing apparatus 1000, and stores the job in the mass storage 500 (step 2-2B).

The user who gives the print instruction holds up the IC card 410 over the card reader 400 (step 3-1). The card reader 400 reads the card ID 211 from the IC card 410, and notifies the card ID 211 to the printing apparatus 1000 (step 3-2). The printing apparatus 1000 inquires of the LDAP server 200 the user name corresponding to the received card ID 211 (step 4-1). The LDAP server 200 searches the LDAP directory 201, and transmits the found user name to the printing apparatus 1000 (step 4-2). The printing apparatus 1000 obtains the job corresponding to the user name from the mass storage 500 (step 5-1), and the mass storage 500 transmits the corresponding job to the printing apparatus 1000 (step 5-2). The printing apparatus 1000 displays one of the received jobs on the display. If the user meanwhile holds up the IC card 410 over the card reader 400, the corresponding job is deleted (step 6-1). If the user does not hold the IC card 410 over the card reader 400, the corresponding job is output as it is (step 6-2). The printing apparatus 1000 repeats step 6-1 and step 6-2 for the number of the jobs obtained in step 5-2.

Next, the embodiment of the secure print system 1b according to the present embodiment will be described with reference to FIG. 41. FIG. 41 is a figure illustrating the embodiment of the secure print system 1b.

The user logs on to the client PC 300 (step 1-1), and gives the print instruction of data (step 1-2). The printer driver generates the job from the data and transmits the job to the printer server 101 (step 2-1). The printer server 101 stores the job in the file system (step 2-2), extracts bibliographic data from the job, and registers the bibliographic information (step 2-3). The user who gives the print instruction holds up the IC card 410 over the card reader 400 (step 3-1). The card reader 400 reads the card ID 211 from the IC card 410, and notifies the card ID 211 to the printing apparatus 1000 (step 3-2). The printing apparatus 1000 inquires of the authentication server 102 the user name corresponding to the received card ID 211 (step 4-1). The authentication server 102 searches the authentication table, and transmits the found user name to the printing apparatus 1000 (step 4-2). The printing apparatus 1000 asks the printer server 101 to obtain the job list corresponding to the user name (step 5-1). The printer server 101 searches the bibliographic data (step 5-2), and transmits the list to the printing apparatus 1000 (step 5-3). The printing apparatus 1000 displays one of the received jobs on the display. If the user meanwhile holds up the IC card 410 over the card reader 400, the deletion request is issued to the printer server 101 (step 6-2). If the user does not hold the IC card 410 over the card reader 400, the print instruction is issued to the printer server 101 to print the job of the user (step 6-2). The printer server 101 searches the bibliographic information for the job of the corresponding user (step 6-3), and obtains the actual job data from the file system based on the bibliographic data (step 6-4). The printer server 101 issues the print instruction to the printing apparatus 1000 (step 6-5), and the printing apparatus 1000 outputs the data according to the instruction (step 6-6). The printing apparatus 1000 repeats step 6-1 and step 6-6 for the number of the jobs obtained in step 5-3.

According to the embodiment of the present invention, a mechanism can be provided that enables deleting the print data even with such printer that is unable to delete a print data with an operation unit. In addition, a mechanism to avoid lagging printing work can be provided even in a case where the authentication cannot be performed because, for example, the authentication server is down.

In the secure print system 1a and the secure print system 1b according to the present embodiment, the print data can be deleted even with such printer that is unable to delete a print data with an operation unit. Furthermore, the secure print system 1a and the secure print system 1b according to the present embodiment are high-availability systems that do not stop the work of the user because printing can be performed even in a case where the authentication server does not operate due to some reason.

The secure print system 1a according to the present embodiment does not use the printer server, and thus is a more securely protected system that solves the problem that the print data is accumulated in the printer server to become a security hole. In addition, because the printer server is not used, the secure print system 1a can reduce the cost in establishing the environment for secure printing, and thus is a more inexpensive system. In addition, the secure print system 1a according to the present embodiment does not use the printer server, and thus is a system more highly convenient for the user because the secure print system 1a allows the client to introduce the print job through the completely same operation without being aware of the difference, regardless of whether the user performs the stored printing performing secure printing or does not perform the stored printing when the authentication server is down. In addition, the secure print system 1a according to the present embodiment does not use the printer server and does not need the setting of the printer driver to be changed, and thus is a system that is easy to be introduced and installed and that saves trouble.

### Third Embodiment

The previous embodiments described the configuration that in a case where the user deletes the job, the user once holds up the IC card over the card reader, thereafter checks the job displayed on the panel, and determines to delete the jobs one by one by holding up the IC card over the card reader if it is a job that the user wants to delete. The present embodiment describes a configuration to delete all the jobs of the user in a case where the IC card is held over the card reader for a certain period of time. The present embodiment will be described with reference to FIG. 42 to FIG. 44. It should be noted that the present embodiment can be realized by replacing the above-described FIG. 8 with FIG. 42, replacing FIG. 12 of the previous embodiments with FIG. 43, and replacing FIG. 16 of the previous embodiments with FIG. 44. The other figures are equivalent to those of the previous embodiments, and other matters are similar to the previous embodiments.

First, the data used by the present embodiment will be described with reference to FIG. 44. FIG. 44 is a figure illustrating the details of the setting information 802 according to the present embodiment. The setting information 802 has the suffix 831, the identification code 832, the primary server 833, the primary port 834, the secondary server 835, the secondary port 836, the user 837, the password 838 and an all-deletion waiting time 839. The all-deletion waiting time 839 stores a value for being compared with a time for which the IC card is held over the card reader. It is assumed that this time is arbitrarily configured, and for example, can be set to a time (predetermined time) such as three seconds. It should be noted that the setting information 802 illustrated in FIG. 44 is made by adding the all-deletion waiting time 839 to the setting information 802 illustrated in FIG. 16.

Next, the detailed processings of the present embodiment will be described with reference to FIG. 42 and FIG. 43. FIG. 42 is a flowchart illustrating an example of the print job output processing procedure according to the present embodiment. FIG. 43 is a flowchart illustrating an example of the print job output processing procedure according to the present embodiment. Hereinbelow, the processings performed by the NIC 700 will be described, distinguishing between the function of the application 800 and the function of the NIC OS 900. Accordingly, it is assumed for the sake of convenience that the subjects of the processings are the application 800 and the NIC OS 900. It should be noted that in reality the subject that performs the processings is the NIC 700. The NIC 700, which is hardware, executes later-described processings by working together with the application 800 or the NIC OS 900, which are software.

First, the details of the processing of print job output according to the present embodiment will be described with reference to FIG. 42. In FIG. 42, the application 800 stores a time for which the IC card 410 (memory medium) is held over the card reader. On the other hand, the NIC 700 transmits the authentication request including the user information 210 to the LDAP server 200. In addition, the NIC 700 makes a determination whether the NIC 700 can communicate with the LDAP server 200. In addition, in a case where the NIC 700 cannot communicate with the LDAP server 200, the NIC 700 turns off a setting of storing the print data to the mass storage 500. In addition, in a case where the NIC 700 can communicate with the authentication server and where the setting of storing the print data to the mass storage 500 is turned off, the NIC 700 turns on that setting again.

As illustrated in FIG. 42, the card reader 400 detects the IC card 410 (memory medium), and reads the card ID 211 recorded in the IC card 410 (step S100), and the NIC OS 900 transmits the read information to the application 800 (step S101). It is assumed that this reading obtains the card ID by reading a special area of the IC card (memory medium). In addition, this special area may also store the identification information of the card or the identification information of the user. In a case where the card is detected in step S100 of FIG. 42, the card reader 400 conveys (transmits) to the NIC OS 900 the information indicating that the card including the card ID of the IC card is held over the card reader, and the NIC OS 900 notifies (transmits) to the application 800 the information indicating that the card including the card ID of the IC card is held over the card reader. It should be noted that the card ID may also be referred to as user identification information for identifying the user because the card ID is uniquely associated with the user name in the LDAP server 200. Upon receiving the information indicating that the card including the card ID of the IC card is held over the card reader, the application 800 obtains the current clock time in units of seconds, and stores the clock time as “IC card held timestamp” (step S101-1). The reason why the current clock time is obtained here is to later calculate the time for which the IC card 410 (memory medium) is held over the card reader.

The card reader 400 detects that the IC card 410 (memory medium) held over the card reader in the previous paragraph is released from the card reader, and conveys (transmits) to the NIC OS 900 the information indicating that the card including the card ID of the IC card 410 is released (step S101-2). In addition, the NIC OS 900 notifies (transmits) to the application 800 the conveyed (transmitted) information indicating that the card including the card ID is released (step S101-3).

The application 800 receives the information indicating that the card including the card ID is released, and obtains the time (“IC card held timestamp”) for which the IC card 410 (memory medium) is held over the card reader 400 to store the time in the RAM 4002 (step S101-4). Specifically, the application 800 obtains the current clock time, in units of seconds, at which the information indicating the card including the card ID is released is received, and stores the current clock time as “IC card released timestamp.” Then, the difference from “IC card held timestamp” stored in step S101-1 is calculated and stored in the RAM 4002 (the time for which the IC card is held over the card reader is determined). It is assumed that this calculation result is the time for which the IC card 410 is held over the card reader. It should be noted that although the time at which the card is held, the time at which the card is released, and the time for which the card is held are calculated in seconds but may be calculated in units of milliseconds in a case where precise check is desired. In addition, it should be noted that such configuration may also be employed that the calculation method of the time from when the IC card is held over the card reader and to when the IC card is released therefrom does not use the timestamp but starts a timer when the information indicating that the IC card is held over the card reader is received and obtains the time when the information indicating that the IC card is released is subsequently received. The processings from step S102 to step S108 are similar to those of the previous embodiments and are thus omitted from the description. In addition, although the present embodiment is also configured to use the authentication performed by holding up the IC card over the card reader, the present embodiment may be configured to use the authentication that uses information about fingerprints or hand and finger veins (biometrics information) just as the previous embodiments. In this case, the embodiment can be realized by replacing the card reader 400 with a reader (reading unit) for reading an object of reading such as finger and hand. Furthermore, the time for which the card is held over the card reader is considered to include the time for which finger and hand (object of reading) is placed over the reader (reading unit) in addition to the time for which the IC card (object of reading) is held over the card reader (reading unit), so that the switching can also be made according to this time as to whether all the print jobs are deleted or the print job is deleted one by one.

Next, the processing of print job output subsequent to FIG. 11 of the present embodiment will be described with reference to FIG. 43. In FIG. 43, the application 800 checks the number of the jobs in the execution list 804. In addition, the application 800 causes the processing to be branched according to the time for which the IC card 410 (memory medium) is held over the card reader.

As illustrated in FIG. 43, the application 800 checks the number of pieces of the job information 820 in the execution list 804 (step S132). In a case where the number of pieces of the job information 820 in the execution list 804 is zero piece, the application 800 performs the user notification processing upon selecting the message 5 “AP NO JOB” from among the messages illustrated in FIG. 18 (step S133). In a case where the number of pieces of the job information 820 in the execution list 804 is not zero piece (i.e., is equal to or more than one piece), the processing is returned back to step S140.

The application 800 obtains from the RAM 4002 the time for which the IC card 410 (memory medium) is held over the card reader, which time is stored in step S104-4, and makes a determination whether the time for which the card is held over the card reader is equal to or more than a certain period of time (makes a determination whether the time for which the IC card is held over the card reader is a predetermined time) (step S140). Specifically, “IC card held time” calculated in step S101-4 and the all deletion waiting time 839 configured in the setting information 802 are compared. As a result of comparison, if “IC card held time” is longer, it is determined that the card is held over the card reader for the certain period of time or more (YES in step S140). On the other hand, as a result of comparison, if the all deletion waiting time 839 is longer, it is determined that the card is not held over the card reader for the certain period of time or more. It should be noted that the setting of the all deletion waiting time 839, serving as the criteria of determination, can be changed, and thus the present embodiment can flexibly cope with the environment of the user such as an environment where there exists a user who holds up the IC card 410 over the card reader for a long time even though he or she wants to perform normal printing and an environment where there exists a user who wants to quickly perform all deletion.

The application 800 refers to the execution list 804 and deletes all the jobs of the user corresponding to the card ID from the mass storage (memory unit) (step S141). Specifically, the job information 820 is retrieved from the execution list 804. Next, the file name 822 held in the job information 820 is obtained. Next, the job 310 corresponding to the file name 822 is searched in the file system 501 and is deleted. The above-described processings are repeated for the number of the jobs stored in the execution list 804.

It should be noted that step S134 and step S138 are similar to those of the previous embodiments and are thus omitted from the description. In step S140, the time for which the IC card 410 (memory medium) is held over the card reader, which time is stored in step S101-4, is obtained from the RAM 4002. In a case where it is determined that the time for which the card is held over the card reader is not equal to or more than the certain period of time (NO in step S140), the processing proceeds to step S134, and the job name 823 is displayed on the panel (identification information notification). Every time the IC card is held over the card reader, the job corresponding to the job name is deleted from the mass storage (memory unit).

The above processings (step S140 and step S141) enable the user to easily delete all the jobs through such easy operation that the user holds up the IC card over the card reader for a longer time than usual. Thus, even in such cases where the user has introduced many jobs by mistake or where many jobs remain that are no longer needed to be printed, it is not necessary for the user to delete the jobs one by one as in the previous embodiments, and a more easy-to-use mechanism is achieved. In addition, if the time for which the IC card is held over the card reader is short, the processings similar to the previous embodiments can be performed, and thus a switching can be made between the previous embodiments and the present embodiment (third embodiment). Thus, the user makes a determination whether to use a method to delete all the jobs or a method to print/delete the jobs one by one according to the object, and the deletion method can be switched on the printing apparatus according to the operation (time) of holding up the IC card over the card reader. It should be noted that although the present embodiment is described with the configuration of FIG. 40, the present embodiment may be achieved with the system having the printer server 101 of FIG. 41 (the secure print system 1b).

As described above, according to the embodiment of the present invention, a mechanism to delete the jobs by holding up the card over the card reader can be provided. In addition, a mechanism to delete all the jobs of the user by holding up the card over the card reader for a longer time can be provided.

Exemplary embodiments of the secure print system and the network interface apparatus according to the present embodiments are described hereinabove with reference to the attached figures, but are not limited to the above-described embodiments. Various modifications and variations may be made within the technical concepts disclosed in the claims. Furthermore, it should be appreciated that these modifications and variations are included within the technical scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2008-065578, filed Mar. 14, 2008, 2008-148848, filed Jun. 6, 2008 and 2009-011722, filed Jan. 22, 2009 which are hereby incorporated by reference herein in their entirety.

What is claimed is:

1. A network interface apparatus connected to an image forming apparatus and communicating with an information processing apparatus for transmitting a print data and an authentication server for performing an authentication of a user, the network interface apparatus comprising:
a reception unit that receives the print data from the information processing apparatus;
a memory unit that stores the print data;
a request transmission unit that transmits, according to a reception of user identification information for identifying the user, an authentication request including the user identification information to the authentication server;
a determination unit that determines whether a communication with the authentication server is available;
an acquisition unit that obtains the print data according to the user identification information from the print data stored by the memory unit in a case where the determination unit determines that the communication with the authentication server is available;
a cancellation unit that cancels a setting of causing the memory unit to store the print data received by the reception unit in a case where the determination unit determines that the communication with the authentication server is not available; and
a data transmission unit that transmits the print data obtained by the acquisition unit, or the print data received by the reception unit in a case where the setting is canceled by the cancellation unit, to the image forming apparatus to cause the image forming apparatus to print the print data.

2. The network interface apparatus according to claim 1 further comprising:
a connection confirmation unit that periodically confirms whether a communication with the authentication server is available; and
a first reconfiguration unit that reconfigures the setting in a case where the connection confirmation unit determines that the communication with the authentication server is available and where the setting of causing the memory unit to store the print data received by the reception unit is canceled.

3. The network interface apparatus according to claim 1 further comprising:
a second reconfiguration unit that reconfigures the setting in a case where the determination unit determines that the communication with the authentication server is available and where the setting of causing the memory unit to store the print data received by the reception unit is canceled.

4. The network interface apparatus according to claim 1, wherein the user identification information is associated with sub-user information, the sub-user information being information of a user different from the user corresponding to the user identification information.

5. The network interface apparatus according to claim 4, wherein the acquisition unit obtains a print data according to the sub-user information in addition the print data according to the user identification information from the print data stored by the memory unit.

6. The network interface apparatus according to claim 1, wherein the cancellation unit excludes a port number configured in the print data from an object of monitoring.

7. The network interface apparatus according to claim 1, wherein the memory unit encrypts and stores the print data received by the reception unit.

8. A print control method for a network interface apparatus connected to an image forming apparatus and communicating with an information processing apparatus for transmitting a print data and an authentication server for performing an authentication of a user, the print control method comprising:
a reception step that receives the print data from the information processing apparatus;
a memory step that stores the print data to a memory unit;
a request transmission step that transmits, according to a reception of user identification information for identifying the user, an authentication request including the user identification information to the authentication server;
a determination step that determines whether a communication with the authentication server is available;
an acquisition step that obtains the print data according to the user identification information from the memory unit in a case where the determination step determines that the communication with the authentication server is available;
a cancellation step that cancels a setting of storing to the memory unit the print data received in the reception step in a case where the determination step determines that the communication with the authentication server is not available; and
a data transmission step that transmits the print data obtained in the acquisition step, or the print data received in the reception step in a case where the setting is canceled in the cancellation step, to the image forming apparatus to cause the image forming apparatus to print the print data.

9. A computer-readable memory medium that stores a print control program for executing the print control method according to claim 8.

10. An image forming apparatus having a network interface apparatus communicating with an information processing apparatus for transmitting a print data and an authentication server for performing an authentication of a user, the network interface apparatus comprising:
a reception unit that receives the print data from the information processing apparatus;
a memory unit that stores the print data;
a request transmission unit that transmits, according to a reception of user identification information for identifying the user, an authentication request including the user identification information to the authentication server;
a determination unit that determines whether a communication with the authentication server is available;
an acquisition unit that obtains the print data according to the user identification information from the print data stored by the memory unit in a case where the determination unit determines that the communication with the authentication server is available;
a cancellation unit that cancels a setting of causing the memory unit to store the print data received by the reception unit in a case where the determination unit determines that the communication with the authentication server is not available; and
a data transmission unit that transmits the print data obtained by the acquisition unit, or the print data received by the reception unit in a case where the setting is canceled by the cancellation unit, to the image forming apparatus to cause the image forming apparatus to print the print data,
the image forming apparatus comprising:
a reception unit that receives the print data that the transmission unit transmits from the network interface apparatus; and
an output unit that outputs the print data received by the reception unit.

11. A network interface apparatus connected to an image forming apparatus and communicating with an information processing apparatus for transmitting a print data, the network interface apparatus comprising:
a print data reception unit that receives the print data transmitted from the information processing apparatus;
a print data memory unit that stores the print data received by the print data reception unit;
a user identification information reception unit that receives user identification information for identifying a user, the user identification information being obtained by reading an object of reading;
a print data identification information transmission unit that transmits print data identification information to the image forming apparatus to notify, for a predetermined period of time, the user of the print data identification information for identifying the print data stored by the print data memory unit; and
a print data deletion unit that deletes from the print data memory unit the print data corresponding to the print data identification information being notified, in a case where the user identification information reception unit receives the user identification information while the print data identification information transmission unit transmits the print data identification information to notify the user for the predetermined period of time.

12. The network interface apparatus according to claim 11 further comprising:
a user identification information memory unit that stores the user identification information received by the user identification reception unit,
wherein the print data deletion unit causes the print data identification information transmission unit to transmit the print data identification information, so that while the user is notified for the predetermined period of time, the print data deletion unit deletes the print data in a case where the user identification information received by the user identification information reception unit corresponds with the user identification information stored in the user identification information memory unit.

13. The network interface apparatus according to claim 11, wherein the network interface apparatus communicates with an authentication server performing an authentication of the user,
the network interface apparatus further comprising:
an authentication request transmission unit that transmits an authentication request including the user identification information to the authentication server in a case where the user identification information reception unit receives the user identification information; and
a print data identification information acquisition unit that obtains the print data identification information of the print data corresponding to the user identification information in a case where the user identification information is authenticated upon the authentication request having been transmitted to the authentication server by the authentication request transmission unit,
wherein the print data identification information transmission unit transmits the print data identification information obtained by the print data identification information acquisition unit.

14. The network interface apparatus according to claim 11 further comprising:
a communication availability determination unit that determines whether a communication with the authentication server is available;
a cancellation unit that cancels a setting of storing the print data received by the print data reception unit to the print data memory unit in a case where the communication availability determination unit determines that the communication with the authentication server is not available; and
a first print data transmission unit that transmits the print data received by the print data reception unit to the image forming apparatus without storing the print data in the print data memory unit in a case where the setting is canceled by the cancellation unit.

15. The network interface apparatus according to claim 14, wherein the communication availability determination unit periodically determines whether the communication with the authentication server is available in a case where the setting of storing the print data to the print data memory unit is canceled by the cancellation unit.

16. The network interface apparatus according to claim 14 further comprising a setting unit that configures the setting of storing the print data to the print data memory unit in a case where the communication availability determination unit determines that the communication with the authentication server is available and where the setting of storing the print data to the print data memory unit is canceled.

17. The network interface apparatus according to claim 14 further comprising:
a time information memory unit that stores time information when the communication with the authentication server can be established in the communication availability determination,
wherein the print data identification information notification unit determines whether the print data identification information is to be notified, according to the time information and memory time information at which the print data is stored to the print data memory unit.

18. The network interface apparatus according to claim 11 further comprising a second print data transmission unit that transmits to the image forming apparatus the print data corresponding to the print data identification information being notified in a case where a print instruction is input via an input unit of the image forming apparatus while the print data identification information transmission unit transmits the print data identification information to notify the user for the predetermined period of time.

19. The network interface apparatus according to claim 11 further comprising:
a time measuring unit that determines a time for which the object of reading is being read;
a time determination unit that determines whether the time determined by the time measuring unit is a predetermined period of time; and
an all print data deletion unit that deletes all the print data corresponding to the user identification information from the print data memory unit in a case where the time determination unit determines that the time determined by the time measuring unit is the predetermined period of time.

20. The network interface apparatus according to claim 19, wherein the print data identification information transmission unit transmits the print data identification information to the image forming apparatus to notify, for the predetermined period of time, the user of the print data identification information for identifying the print data stored in the print data memory unit in a case where the time determination unit determines that the time determined by the time measuring unit is not the predetermined period of time.

21. The network interface apparatus according to claim 11, wherein the user identification information received by the user identification information reception unit is information obtained by reading a predetermined area of a memory medium in a case where the memory medium is held over a reading unit of the image forming apparatus.

22. A control method for a network interface apparatus connected to an image forming apparatus and communicating with an information processing apparatus for transmitting a print data, the control method comprising:
a print data reception step that receives the print data transmitted from the information processing apparatus;
a writing step that writes the print data received in the print data reception step to a memory unit;
a user identification information reception step that receives user identification information for identifying a user, the user identification information being obtained by reading an object of reading;
a print data identification information transmission step that transmits print data identification information to the image forming apparatus to notify, for a predetermined period of time, the user of the print data identification information for identifying the print data stored in the memory unit; and
a print data deletion step that deletes from the memory unit the print data corresponding to the print data identification information being notified, in a case where the user identification information reception step receives the user identification information while the print data identification information transmission step transmits the print data identification information to notify the user for the predetermined period of time.

23. A computer-readable memory medium that stores a print control program for executing the control method according to claim 22.

24. An image forming apparatus that can communicate with an information processing apparatus for transmitting a print data, the image forming apparatus comprising:
a print data reception unit that receives the print data from the information processing apparatus;
a print data memory unit that stores the print data received by the print data reception unit;
a user identification information reception unit that receives user identification information for identifying the user;
a print data identification information notification unit that notifies, for a predetermined period of time, the user of print data identification information for identifying the print data stored in the print data memory unit; and
a print data deletion unit that deletes from the print data memory unit the print data corresponding to the print data identification information being notified, in a case where the user identification information reception unit receives the user identification information while the print data identification information notification unit notifies the user for the predetermined period of time.
